(19) United States
(12) Patent Application Publication
(10) Pub. No.: US 2013/0251524 A1
(43) Pub. Date: Sep. 26, 2013

(54) Wind Turbine Generator

(71) Applicant: Charles Grigg, Westport, CA (US)

(72) Inventor: Charles Grigg, Westport, CA (US)

(21) Appl. No.: 13/991,428

(22) PCT Filed: Dec. 9, 2011
(86) PCT No.: PCT/US11/64047

§ 371 Date: Jun. 4, 2013

Related U.S. Application Data
(60) Provisional application No. 61/421,522, filed on Dec. 9, 2010.

(30) Foreign Application Priority Data
Jan. 12, 2011 (US) PCT/US2010/021012

(51) Int. Cl. F03D 9/00

(52) U.S. Cl. CPC F03D 9/002
USPC 416/9

(57) ABSTRACT

A wind turbine includes a plurality of pivot shafts that are in paired parallel relationship and engaged to a central drive shaft, each pivot shaft supports a wing. Each pivot shaft rotates cyclically through 90° to move each wing from a wind-engaging orientation (drive position) in which the wing presents a flat surface approximately transverse to the incident wind, to a minimum dragposition (glide position). A gear transmission links the pivot shafts for sequential rotation in concert between the drive and glide positions.

### CROSS-REFERENCE TO RELATED APPLICATIONS

This application is a continuation in part of international application No. PCT/US2011/021012 filed Jan. 12, 2011 and claims the benefit of: U.S. application Ser. No. 12/657,136 filed Jan. 13, 2010; and U.S. Provisional Application No. 61/382,346 filed Sep. 13, 2010; and, U.S. Provisional Application No. 61/421,522 filed Dec. 9, 2010.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to wind turbines and, more particularly, to wind turbine designs that maximize the frontal contact area of the turbine wings with the wind incident thereon.

2. Background of the Invention

The recent renewed interest in renewable energy sources has highlighted wind energy and the use of wind turbines to generate electrical power by harnessing the energy of wind currents. Indeed, many very large turbines have been installed or are being built around the world, typically employing towers 50 meters or more in height and turbine blades that may exceed 30 meters in length. These installations are successful in generating large amounts of electrical power, and because of their relatively slow rotational speed they tend to avoid negative impacts on local bird populations. However, it is apparent that the frontal contact area of the turbine blades of one of these typical turbines is a very small fraction of the virtual disk surface swept by the blades in a complete rotation, which leads to the conclusion that a great amount of wind energy is passing through the swept area of the turbine without contacting a blade or contributing any useful work toward power generation. Thus these turbines are necessarily low efficiency devices, when efficiency is calculated at a ratio of generated power to the wind power passing through the turbine's swept area.

In general, the long length of the blades tends to limit their width because of considerations of increased mass rotating, and increased lateral wind loads therefrom, at the top of the tower. Furthermore, the typical wind turbine blades rely on aerodynamic lift to generate rotational force, and the lift characteristic is often not directly related to blade width.

3. Description of Related Art

There are known in the prior art various attempts to devise windmills that employ flat blades to confront the flowing fluid transversely and receive the full force of the incident fluid, whether water or air. For example, U.S. Pat. No. 1,111,350 to Bayley describes a water current motor that has a central vertical shaft, and a pair of transverse pivot shafts extend through the central vertical shaft to support a pair of paddle-like blades, one at each end of each pivot shaft. The blades extend perpendicularly to their respective shafts, and the blades on each shaft are offset 90° each from the other about the axis of the pivot shaft. As one blade rotates into the wind it is urged thereby to rotate downwardly to a vertical position to catch the wind fully, while the blade at the other end of the shaft rotates into a feathered position. A cylindrical frame is secured about the central vertical shaft and is connected by rigid links thereto, and also connected to the outer ends of the pivot shafts for their support.

This device does not maximize the amount of power extracted from incident winds or fluid flows, and the torque it generates is not counterbalanced by any mechanical force other than the expedient of anchoring it to fixed points. Moreover, the pivot shafts extend diametrically through the central vertical shaft, and this factor prevents the use of a hollow tubular central shaft, a disadvantage that will be further explored in the following description of the present invention. In addition, the pivot shafts are supported at an upper quarter and medial portion of the central vertical shaft, causing the fluid force developed by the blades to be applied to the central and upper quarter portions of the vertical shaft. These forces are unbalanced and create unbalanced intake and discharge flows.

### BRIEF SUMMARY OF THE INVENTION

The present invention generally comprises a wind turbine design that maximizes the frontal contact area of the turbine wings with the incident wind stream, so that a large fraction of the energy of the incident wind is converted to useful work. The unique construction of the wind turbine thus yields a more efficient wind turbine that is adaptable to many uses, as will be described below. Note that although this initial description relates to wind-driven turbines, it applies equally to any fluid flow, such as river currents, tidal flow, hydroelectric power generation, and the like.

The invention introduces the use of turbine wings mounted on pivot shafts that are mounted in paired relationship and transversely mounted on a central drive shaft. The pivot shafts all rotate about the central drive shaft. Each pivot shaft enables its respective wings to rotate cyclically from a wind-engaging orientation (drive position) in which the wing presents a flat surface approximately transverse to the incident wind, to a minimum drag position (glide position) that enables the wing to rotate around the central drive shaft with minimum energy loss until it returns “into the wind” and repeats the cycle and rotates the pivot shaft and moves into drive position once again.

Also, each pivot shaft supports a pair of wings, each wing secured to a respective end of the pivot shaft. Moreover, each wing is oriented so that the axis of the pivot shaft lies in the virtual plane that contains the wing. In addition, the two wings of each pair on a shaft are disposed in planes that are offset by approximately 90° about their pivot shaft.

The paired relationships of the pivot shafts cause the wings of one shaft to be vertically adjacent the wings of the other shaft. Assuming the central drive shaft extends vertically, the wings of the upper pivot shaft are disposed so that they rotate cyclically between extending upwardly (vertically) in the drive position, to the neutral glide (feathered) position. The wings of the lower shaft are disposed so that they rotate cyclically between extending downwardly (vertically) in the drive position, to the neutral glide position. Thus the upper and lower shafts cyclically and repeatedly rotate wings into the drive position, the former rotating upwardly and the latter rotating downwardly, so that the entire airflow space is blocked by the wings rotating through the drive position. Thus these wings are fully deployed to be completely and repeatedly impinged on by the incident wind, the force of the wind on the wings in the drive position pushing the pivot shafts to rotate the central drive shaft about its axis. The rotation of the central drive shaft may be used to do useful work, such as electricity generation, pumping, and the like.

The invention also provides a support structure for the central drive shaft, the pivot shafts, and the wings. Each pivot shaft is supported in a journal joined to the central drive shaft, and the preferred embodiment provides two pairs of two pivot shafts, for a total of four pivot shafts and eight wings. A generally cylindrical outer frame or strut structure extends coaxially about the central drive shaft, the frame including end assemblies that support the central drive shaft at both its ends. Each end of each pivot shaft is secured in a bushing or bearing in the cylindrical frame, so that the pivot shaft portion where each wing is attached is supported centrally by the central shaft journal and at its outer end by the bushing in the outer frame.

The cylindrical outer frame further introduces a pair of support frame structures, each frame structure extending generally diametrically through the outer frame, spanning the end assemblies of the cylindrical outer frame and each aligned with a respective pair of pivot shafts. The support frame structures are in mutual orthogonal relationship about the axis of the cylindrical frame. Each support frame includes four box-like backstop assemblies, one for each turbine wing at the ends of the pivot shafts that are aligned with the support frame. Each backstop assembly is aligned vertically (parallel to the central drive shaft) and comprised of three linear bumper components joined in a vertical plane as three sides of a rectangular perimeter; two of which are disposed to engage the side edges of a wing in the drive position, the third bumper component being disposed to engage the distal moving edge of a wing when in the drive position.

Each side bumper component is attached to the top and/or bottom cylindrical outer frame as is the one serving the wing tip of each wing. The outer side bumper components serving the upper and lower wings are connected to the side structure which is connected to the upper and lower discs of the spinning turbine frame. The inner side wing backstop may be attached to the main shaft, or in some embodiments have its own side structure that holds the pivot shaft bearings and is also connected to the top and/or bottom disc of the turbine frame. The bumper components are significant in that they receive the majority of the wind force from the wings in the drive position, and transfer that force to the outer frame structure, thus unloading many potential stresses from the pivot shafts and their attachments to their wings, while creating the torque that drives the cylindrical outer frame to rotate the central drive shaft.

The backstop assemblies are also provided with (fixed or hinged) backstop fairings for current capture by forming a boxlike structure that blocks airflow spilling off the wing in the drive position. Each wing typically has only two box fairing panels at the sides of the wing, adjacent the bumper components, as the upper and lower disc of the spinning turbine frame in effect serves as the upper box fairing panel of the three sided box that is sealed when the wing closes on the wingtip cushioned backstop in drive.

The cylindrical outer frame structure may itself be secured within a housing that supports the cylindrical outer frame by a plurality of roller bearings arrayed in two circular arrangements to impinge on the end assemblies of the cylindrical outer frame. This assembly stabilizes the cylindrical outer frame as it rotates.

It is noted that the drive position of the turbine wings coincides with approximately a 90° portion of the angular rotation of the cylindrical outer frame. The (spinning turbine frame or the) outer housing may be configured as a shroud that encloses the non-drive angular portions of the frame or housing, as well as directs the incident wind energy towards the drive position, thus forming a wind intake opening for the assembly. The wind intake may comprise wind deflector panels or surfaces, funnel-like surfaces, or the like.

In a further development of the invention, a pair of wind turbines may be provided, one a mirror image of the other and arranged to rotate in opposite directions. The pair may be disposed in adjacent side-by-side relationship, whereby their wind intake openings are also directly adjacent. The outer housing encloses the pair of turbines and directs wind into the adjacent wind intake openings. The counter-rotating central drive shafts of the two turbines may be mechanically connected to a gear, chain, pulley, or similar mechanism to synchronize and perform useful work. This side-by-side arrangement also permits the torque of one turbine to be neutralized by the torque of the other, so that there is a net zero torque exerted on the housing. In a similar adaptation a pair of wind turbines may be connected end-to end, with central drive shafts aligned and connected to do useful work. The two turbines counter-rotate, so that the net torque on the assembly is effectively zero.

The housing may be provided with a wind vane structure and supported on a windmill mount that rotates about the horizon, whereby the wind vane will turn the housing to point the wind intake opening(s) into the wind direction and take advantage of incident wind from any bearing.

The wind turbine may be built to a size and conformation such that it is portable on a truck bed and easily relocatable to places where the wind is blowing. Thus seasonal wind changes can be exploited without requiring placement of the wind turbine in a fixed location. Likewise, the wind turbine may be mounted on a ship to capture wind energy generate electrical or hydraulic power to be used for propulsion and operating the ship. The ship may be provided with pontoons, or a catamaran hull, to counterbalance the lateral wind force on the turbine.

Although the invention is described above with reference to air flow and wind energy, it may be appreciated that any fluid flow will drive the turbine described herein. Thus there are ample opportunities to exploit water flow, such as river currents, tidal currents, wave action, and dammed water supplies.

Additional embodiments and improvements to the instant invention are described in U.S. Provisional Patent Application No. 61/382,346 filed Sep. 13, 2010 and, U.S. Provisional Application No. 61/421,522 filed Dec. 9, 2010 which applications are incorporated herein by reference as if fully set forth herein.

### BRIEF DESCRIPTIONS OF THE DRAWINGS

FIG. 1 is an enlarged fragmentary perspective view of the hub portion of the wind turbine of the present invention.

FIG. 2 is an enlarged fragmentary perspective view of the hub portion of FIG. 1, viewed from a different angle.

FIG. 3 is an enlarged fragmentary perspective view of the hub portion of FIGS. 1 and 2, including the supports on the pivot shafts that secure the backstop assemblies.

FIGS. 4-7 are a sequence of perspective views of the hub portion and pivot shafts and wings secured thereto.

FIG. 8 is a plan view, and FIG. 9 is a perspective fragmentary view, of a backstop assembly of the invention.

FIG. 10 is a perspective view of the components of the rotating turbine assembly with the pivot shafts and wings omitted to visualize the relationships of the components.

FIG. 11 is a top perspective of the outer support frame of the wind turbine of the invention.

FIGS. 12-15 are a sequence of perspective views showing the incremental movements of the wind turbine components during a quarter cycle of turbine rotation.

FIG. 16 is a perspective view of the support frame structure of the side-by-side twin turbine of the invention.

FIGS. 17 and 18 are a sequence of perspective views showing the incremental movements of the side-by-side twin turbine components during a partial cycle of turbine rotation.

FIG. 19 is a plan view of a side-by-side twin turbine mounted on a turntable and adapted to point into the wind.

FIG. 20 is a plan front elevation of the side-by-side wind turbine with wind foils and nacelle to funnel the wind into the turbine.

FIG. 21 is a cross-sectional plan view of the end-to end water turbine embodiment of the invention.

FIGS. 22 and 23 are plan elevations of two different embodiments for generating power using the turbines of the invention driven by flowing water.

FIG. 24 is a perspective elevation of a twin side-by-side turbine apparatus for generating electrical power.

FIG. 25 is a diagrammatic view of the torque applied to the central drive shaft by the wings of the invention supported on their radially offset pivot axes.

FIG. 26 is a composite illustration depicting four different types of pivot shaft layouts of the present invention.

FIGS. 27A and 27B are a top view and side elevation, respectively, of the pivot shafts and central shaft assembly of the model A arrangement of the fluid turbine of the present invention.

FIG. 28A is a perspective elevation of one embodiment of the model B pivot shaft layout; FIG. 28B is a top view that includes fairing panels; and FIG. 28C-28D are side views of the pivot shafts with drive gears added.

FIG. 29A-29B are sequential perspective views showing a brace extending between paired opposed wings linking the side structures.

FIG. 30 is an exploded view of one embodiment of a gear linkage to join the pivot shafts rotational movement in a model B pivot shaft layout.

FIG. 31 is a perspective view of a modification of the gear arrangement of FIG. 30 in which 90° of circumference of the gear is provided with teeth.

FIG. 32 is a top view of another gear transmission embodiment used with a model C pivot shaft layout.

FIG. 33 is a side elevation of the gear arrangement shown in FIG. 32.

FIG. 34A-34C are side elevations depicting the gear arrangements in the various hub configurations.

FIG. 35 is a top view of the transmission hub showing recessed modular aspects of the gear assemblies and various pivot shaft layouts relative to axis 21 of the invention.

FIG. 36-37 are top and side cross-sectional views depicting recessed gear assemblies incorporated within a model D hub configuration.

FIG. 38A-38C are exploded elevations of the quadra-drive transmission that links the pivot shafts movements through gear connections only.

FIG. 39 is a cross-sectional elevation of the transmission shown in FIG. 38.

FIG. 40A is a perspective view of the transmission depicted in FIGS. 38-39; FIG. 40B-FIG. 40D are top views showing the various transmission components.

FIG. 41 is a perspective view of the ring gear timing transmission embodiment of the invention.

FIG. 42 is a plan layout of the moving gears of the transmission shown in FIG. 41.

FIG. 43 is a perspective view of the stationary ring gear of the transmission shown in FIG. 41.

FIG. 44 is a perspective view of a dual female slider lock of the transmission of FIG. 42.

FIG. 45 is a perspective view of an alternative embodiment of the wing and backstop assembly of the turbine of the invention.

FIG. 46A-46D are layout, exploded, and end views of a further embodiment of the wind fairing of the turbine of the invention.

FIG. 47 is a plan view of a model A hub in which the pivot shafts are held in a horizontally diametrically opposed position relative to the main shaft and surrounding cylindrical wind foil.

FIG. 48 is an exploded view of the sun gear transmission depicted in FIGS. 38-40.

FIG. 49 is a front elevation of a boat electrical generating propulsion system using the turbines of the present invention.

FIG. 50 is a perspective view of consolidated pivot shaft.

FIG. 51 is an illustration of a Dual drive transmission 400 with consolidated pivot shafts.

FIG. 52 illustrates two perpendicular side views of transmission 400.

FIG. 53 is an illustration of transmission pivot shaft 257 with its gears 255

FIG. 54 is an illustration of transmission socket gears 258 and 259 with outer gears 256

### DETAILED DESCRIPTION OF THE INVENTION

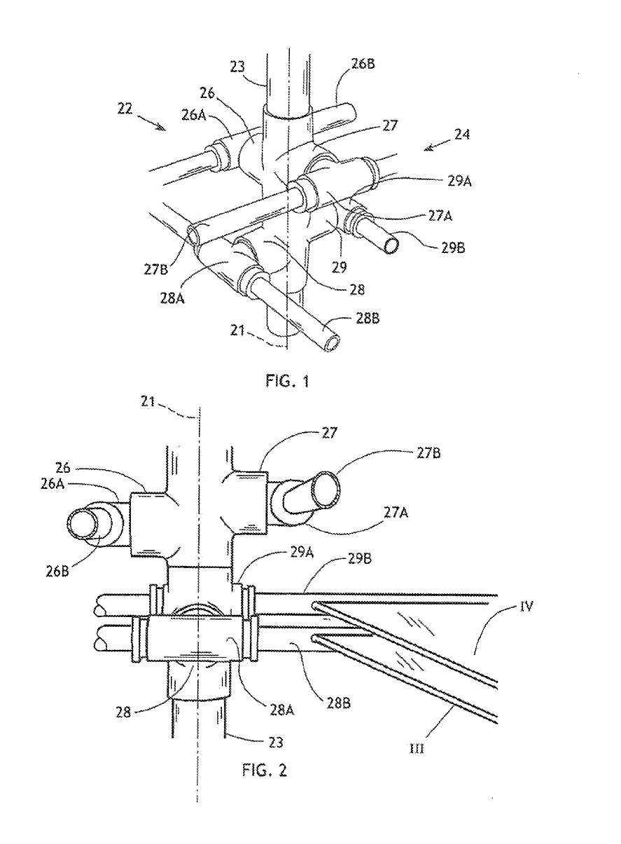

The present invention generally comprises a wind turbine that is designed to maximize the amount of energy extracted from the ambient wind currents. The wind turbine is constructed as a modular cylindrical assembly having an axis 21 about which it rotates when impinged on by wind or any airflow passing thereby. With regard to FIGS. 1-3, a central component of the wind turbine is a central drive shaft assembly 22 extending coaxially with axis 21 and adapted to rotate thereabout. The drive shaft assembly preferably comprises a hollow drive shaft 23 adapted to be connected to perform useful work, as will be described below. The drive shaft 23 is provided with a hub portion 24 comprised of four bosses 26, 27, 28, and 29 extending generally radially from the drive shaft. The bosses 26 and 27 are disposed in a diametrically opposed, axially offset relationship, and the bosses 28 and 29 are similarly disposed but angularly offset 90° about the axis 21 from the bosses 26 and 27, as shown clearly in FIGS. 1-3.

Each boss 26-29 supports a respective bearing housing 26A-29D, and each bearing housing supports the medial portion of a respective pivot shaft 26B-29B. Note that the pivot shafts extend transversely to the axis 21, and are in the paired, parallel, offset relationships established by the bearing housings 26A-26D.

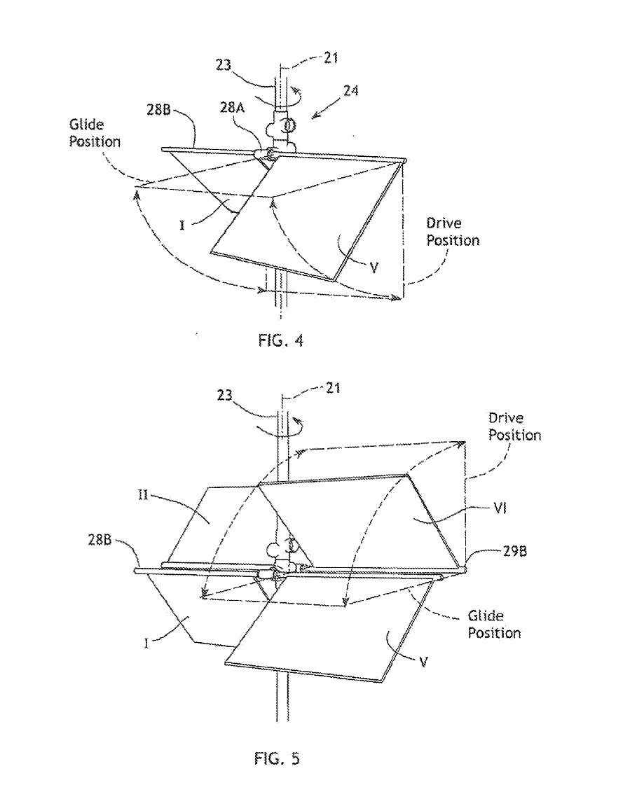

FIG. 4 illustrates the hub portion 24 and isolates the pivot shaft 28B to simplify the explanation. Secured to the opposed ends of shaft 28B is a pair of paddle-like wings 31 and 32, each wing extending radially from the shaft 28B and forming a common plane therewith. The shaft 28B may be longitudinally slotted at each end to secure an inboard edge of the wing 31 or 32, or the wing may be secured by any mechanical means known in the prior art, such as adhesives, solvent or fusion bonding, welding or soldering, swaging or press fitting, or the like. Each wing 31 and 32 is comprised of a rectangular panel that is strong, stiff, durable, and lightweight. It is significant to note that the wings 31 and 31 are angularly offset about the axis of the pivot shaft 28B by 90°. Because of constraints that will be described below, each wing is limited in its rotational movement between a drive position in which the wing extends downwardly and is aligned parallel with the central drive shaft 23, to a glide position in which the wing is aligned transversely to the central drive shaft, as labeled in FIG. 4. Thus in the view of FIG. 4, the wings cannot rotate upward above horizontal, nor can they rotate downward beyond the 90° limit.

It is also significant to note that when one of the wings 31 or 32 is disposed in the drive position, the other wing 32 or 31 is disposed in the glide position. Moreover, each wing exerts a rotational moment about the axis of the shaft 28B, and those moments tend to be counteracting. Thus, when the wings are at approximately the 45° orientation, as shown in FIG. 4, the assembly of the shaft 28B and wings 31 and 32 is in rotational equilibrium.

FIG. 5 depicts in isolation the two paired, parallel, longitudinally offset pivot shafts 28B and 29B on the central drive shaft. Mounted on the opposed ends of shaft 29B are a pair of wings II and VI, so that wings V and VI are adjacent and wings I and II are adjacent. The wings II and VI are secured to the shaft 29B in the same manner as described previously, are formed of similar material, and are also oriented at 90° to each other. Note that the wings II and VI are oriented on shaft 29B so that they rotate between a drive position in which wing II or VI extends upwardly and is aligned parallel to the central axis 21, to a glide or feathered position in which the wing is aligned transversely to the central drive shaft, as labeled in FIG. 5. Thus in the view of FIG. 5, the wings cannot rotate downwardly below horizontal, nor can they rotate upwardly beyond the 90° limit.

Once again, when one of the wings V or VI is disposed in the drive position, the other wing VI or V is disposed in the glide position. Moreover, each wing exerts a rotational moment about the axis of the shaft 29B, and those moments tend to be counteracting. Thus, when the wings are at approximately the 45° orientation, as shown in FIG. 5, the assembly of the shaft 29B and its wings is in rotational equilibrium.

It is significant that the drive positions depicted in FIGS. 4 and 5 are aligned at the same rotational angle of the central drive shaft, and wings V and VI are directly opposed and parallel to the axis 21. In this orientation the wings V and VI are disposed to present a maximum cross-sectional area to the incident wind to extract the greatest energy possible therefrom, as will be explained below. Likewise, the glide positions are aligned at the same rotational angle of the central drive shaft to create the minimum air drag as the wings rotate away from the drive position. This feature enables the wings to rotate around the central drive shaft with minimum energy loss until they return “into the wind” and repeat the cycle and rotate into the drive position once again.

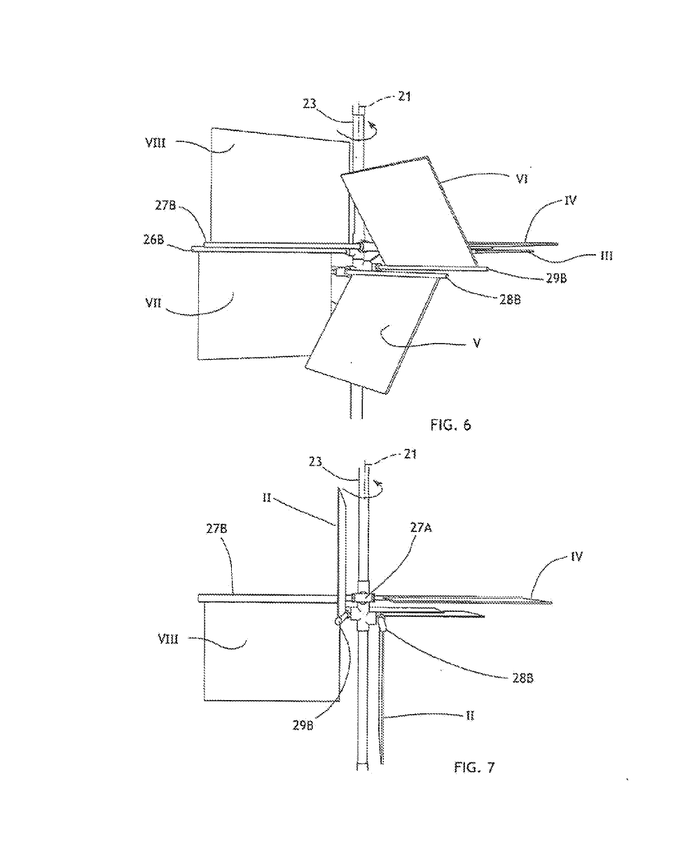

The pivot shafts 26B and 27B are similarly equipped with wings that have the same characteristics and relative orientations as described with respect to shafts 28B and 29B, as shown in FIGS. 6 and 7. Extending from opposed ends of shaft 26B are a pair of wings III and VII, and extending from opposed ends of shaft 27B are a pair of wings IV and VIII. Thus the wings are also paired in oppositional relationship: wings I and II, III and IV, V and VI, VII and VIII are disposed in vertically adjacent fashion. The combined effect of the eight wings and four pivot shafts is that every 90° incremental rotation of the central drive shaft 23 brings a new vertically paired set of opposed wings into the drive position. Likewise, these same vertically paired sets of wings move together to the glide position.

As shown particularly in FIGS. 2 and 6, the vertically paired wings in their glide positions are parallel and closely adjacent, extending perpendicular to the axis 21. These Figures illustrate the significant contribution of the vertical offset of shaft 26A from 27A, as well as shaft 28A from 29A: the vertical offsets prevent the vertically paired wings from colliding when they rotate into the glide position. This enables the feathered wing in the glide position to rotate to the zero degree angle, which accomplishes two things: the wings present a minimal air resistance at the glide position, and the zero degree dwell enables the other wing at the other end of the same pivot shaft to extend to a full 90° in the drive position, thereby maximizing its wind-catching ability. This innovation is an important aspect of the wind turbine of this invention.

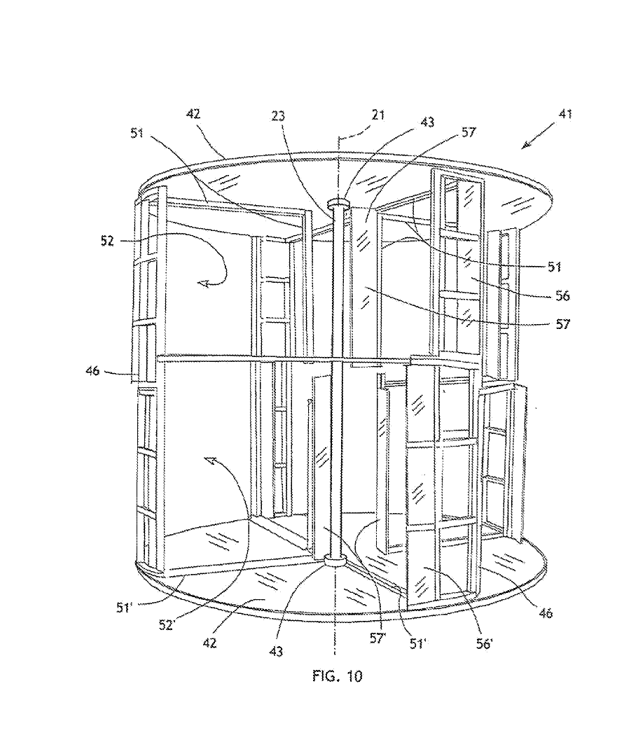

A further significant aspect of the invention is the provision of a support structure for the central drive shaft, the pivot shafts, and the wings. The turbine includes a cylindrical outer frame or strut assembly 41 extending coaxially about the central drive shaft 23, as shown in FIG. 10 (with the pivot shafts and wings removed to visualize the frame 41 components). The frame assembly 41 includes a pair of end assemblies 42 disposed in a parallel, axially spaced relationship, each end assembly having a bushing 43 disposed to engage and secure the central drive shaft 23. In this embodiment the end assemblies are formed by a pair of disk assemblies 44 that provide convenient mounting surfaces for many of the turbine components. The disk assemblies 44 are joined by an open frame construction to form a rigid structure.

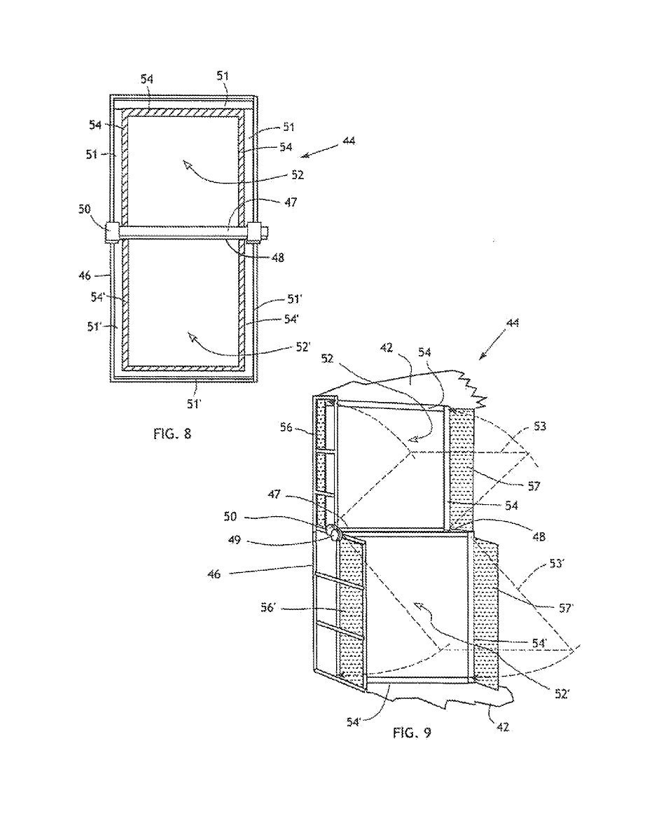

With continued reference to FIG. 10, a major constituent of the structure 41, as shown in FIGS. 8 and 9, is a quartet of box-like backstop assemblies 44, each located at the drive positions of two of the vertically paired wings. Each assembly 44 includes a ladder-like frame 46 at the outer periphery of the structure 41, extending longitudinally between the two end disks 42. The like ends 47 and 48 of two pivot shafts (parallel and axially offset, as described above) extend radially outward from the central drive shaft, and are secured in bearings 49 and 50 supported in a medial portion of the frame 46. At the upper end of the assembly 44 a trio of framing strips 51 are secured to the frame 46 and end disk assembly 42 in a manner to define a rectangular perimeter in conjunction with the pivot shaft 47. This perimeter defines a rectangular opening 52 that is generally open for airflow therethrough. The perimeter defined by strips 51 is dimensioned to be slightly smaller than the respective wing 53 on the pivot shaft 47, whereby the framing strips 51 engage the three free edges of the wing 53 when it reaches its vertical drive position. Thus the strips 51 comprise a mechanical stop that absorbs the force of the wind on the wing and transfers the force through the structure 41 to the central drive shaft 23. In addition, the framing strips 51 are provided with cushioning strips 54 extending therealong to cushion impact and reduce noise output.

Joined to the frame 46 are fairing panels 56 and 57, each extending longitudinally and aligned with a respective side of the rectangular opening 52 and secured to the frame 46 and end disk assemblies 42. The fairing panels, together with the adjacent portion of the end disk assembly 42, form a rectangular, coffer-like wind trap. When the wing 53 reaches the drive position and impinges on the cushion strips 54, the entire rectangular opening 52 is closed and sealed by the wing, leaving no path therethrough for the airflow. The airflow would naturally tend to spread laterally and spill off the wing, but the presence of the fairing panels 56 and 57 and the end surface 42 prevents laminar flow off the wing and maintains the wind pressure for a longer time during the drive position part of the cycle. This effect increases the amount of energy harvested from the wind incident on the turbine.

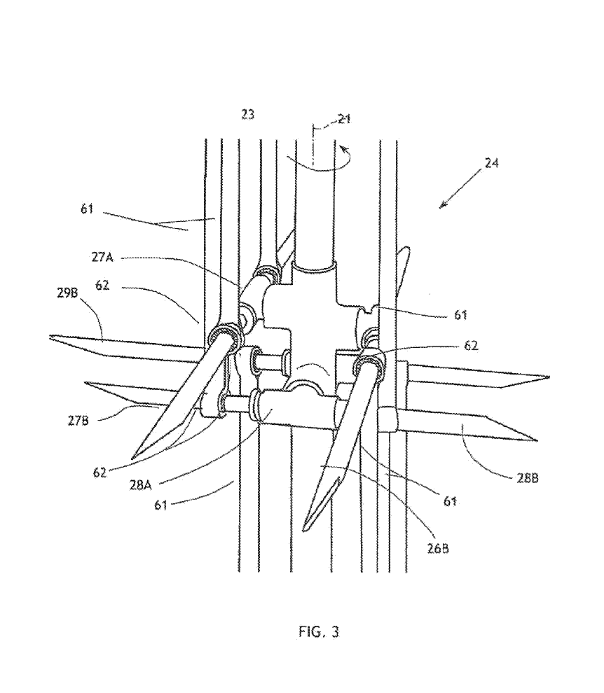

With regard to FIG. 3, the fairing panels 57 and their adjacent framing strips 51, which are disposed adjacent to the central drive shaft 23, may be supported along their longitudinal extents by a mechanical connection to the central drive shaft in the area of the hub 24. The hub 24 may be provided with projections or extensions (not shown) to support the longitudinal edge (the vertical edge in FIGS. 8-10) of the fairing panels 57 and by securing their framing strips to provide mechanical support. Alternatively, the framing strip 51 or 51′ associated with each fairing panel 57 and 57′ may be secured to a respective strut 61 extending from the end disk assembly 42 to a roller bearing housing 62 that rides on its respective pivot shaft (26B-29B). Each strut 61 provides mechanical support to the framing strip and thus the entire edge of its respective fairing panel, from the disk 42 to the respective pivot shaft.

At the lower end of the assembly 44 a trio of framing strips 51′ are secured to the frame 46 and end disk assembly 42 in a manner to define a rectangular perimeter in conjunction with the pivot shaft 48. The construction of the lower end is the same as the upper end but inverted, and the similar components are given the same reference numeral with a prime (′) designation. The similar components function as described above to achieve the same results.

Backstop assembly 44 also enables use of lightweight panels for all of the wings, since the wing is not required to transfer all the force it develops through its single sided connection to the pivot shaft. Rather, the wing transfers the force all around the perimeter of the wing, particularly along the three free wing edges that impinge on the cushioning strips and framing strips of the backstop assembly 44. Thus the wing is relieved of the typical requirement to be sufficiently stiff and strong to transmit all the force it generates through its connection to the shaft of a mechanism, and the wings of this invention may be free of heavy structural reinforcement. As a result, the mass of the pivot shaft/wings assembly is minimal.

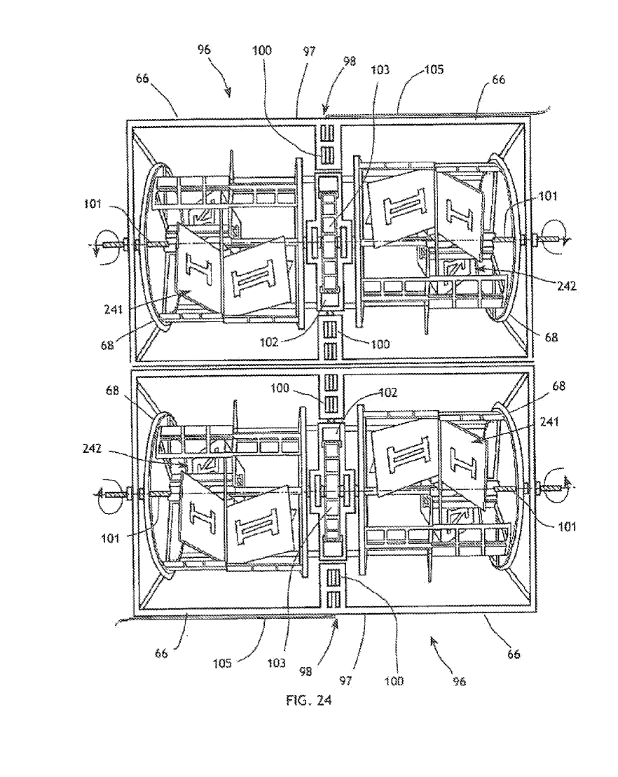

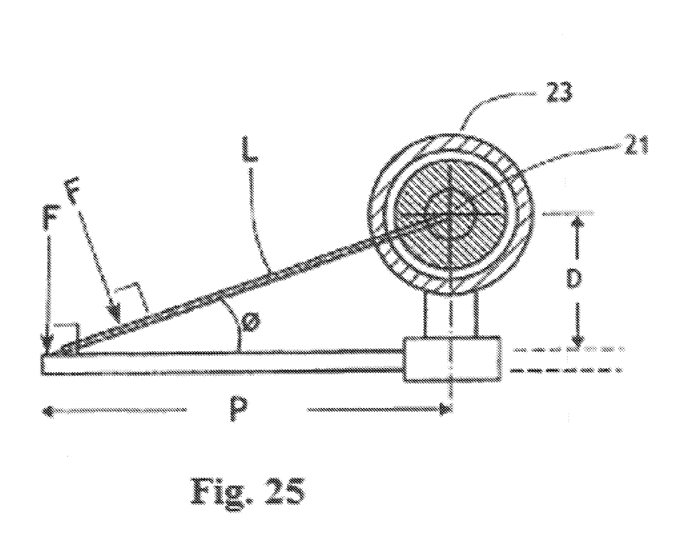

With regard to FIG. 25, the arrangement by which the pivot shafts are offset radially outwardly from the central pivot axis 21 provides an unforeseen benefit. Assuming a pivot shaft L that hypothetically extends directly from the central pivot axis 21, it will exert a torque equal to L-F. In this invention the pivot shaft P is offset radially outwardly from the axis 21 by a distance D. The angle 9 between L and P is given by arctan DIP, and the torque T applied to the central shaft is T=L/cos 9. Given that the cosine function is always less than one, it is clear that the torque applied by the offset pivot shaft P is greater than the radially aligned shaft L, which is cumulative of the prior art arrangements. This torque advantage leads to greater efficiency of this turbine design compared to previous turbine constructions. The backstops provide another contribution in that they receive the majority of the wind force from the wings in the drive position, and transfer that force to the outer cylindrical frame structure 41, thus unloading many potential stresses from the pivot shafts 26A-29A while creating the torque that drives the cylindrical outer frame 41 to rotate the central drive shaft 23.

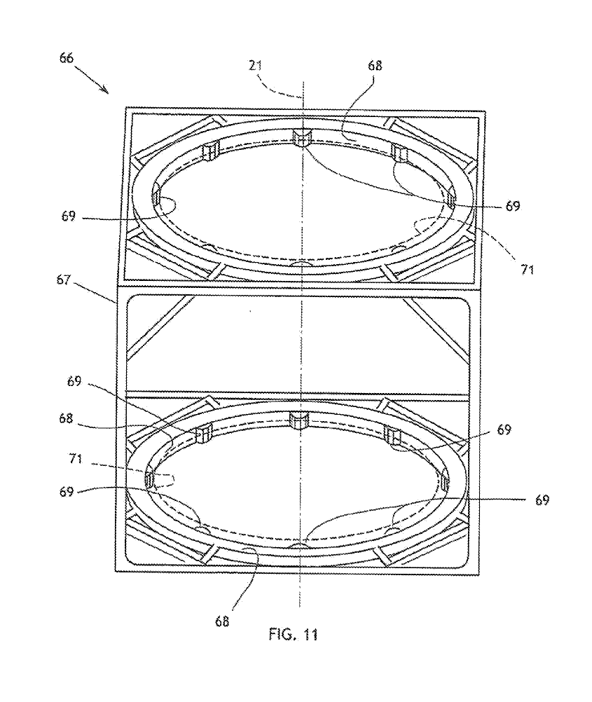

Another key component of the wind turbine is a turbine housing 66, as shown in FIG. 11, which comprises an open frame structure 67 having a generally cubic form. (The frame structure 67 may be clad or partially closed for structural purposes and or to direct fluid flow in an optimal manner.) The housing 66 is strong, stationary, stable, and designed to support the cylindrical outer frame assembly 41 that contains and supports the central drive shaft, the pivot shafts, the wings, and the backstop assemblies secured to the cylindrical frame structure 41. The top and bottom sides of the cube are provided with circular supports 68 that are aligned axially with the axis 21. An optional plurality of roller bearing assemblies 69 are secured in the supports 68 in an array that is symmetrical with the axis 21. Similar bearings are used to support the frame 21 in the axial direction. Moreover, the bearings define an interior opening (indicated by broken line 71) that is dimensioned to receive the perimeter of the end disk assembly 42 of the outer cylindrical frame 41. Indeed, the axial length of the structure 67 is dimensioned so that each of the end disk assemblies 42 is received in a respective opening 71 in a rotatable, secure, supported manner The bearing support of the end disk assemblies, in conjunction with the fact that all parts are dynamically balanced, allow high speed operation with little or no wobble, friction or vibration. Structure 66 can be eliminated in models with the enhanced main shaft extending out a suitable distance from the turbine's lower end assembly 44. With strengthened protruding main shafts and main bearings to accommodate the increased vertical torque and wind load these machines can be tethered on an apparatus above ground or connected to underground concrete pilings.

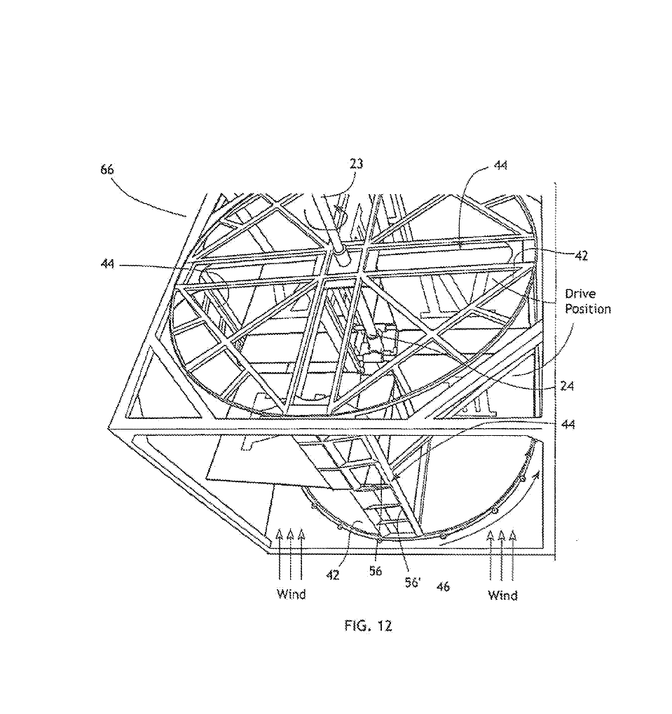

With reference to the serial perspective views of FIGS. 12-15, the central drive shaft 23 and the pivot shafts 26B-29B and their respectively mounted wings I-VIII, and the outer cylindrical frame assembly 41, together with its backstop assemblies 44, are joined together in a unified assembly and secured coaxially within the support housing 66 to comprise a complete wind turbine 71 of this invention. The support housing 66 is secured to a mechanical ground, and the outer cylindrical frame assembly 41 rotates therein riding on the bearings 69. In these views the upper end assembly 42 comprises an open strut construction to replace the solid disk depicted previously, both to show an alternative structure and to enable better visualization of the interior components within the assembly.

In the view of FIG. 12, the wind is arriving from the bottom of the Figure, as labeled, and the outer cylindrical frame assembly 41 and the central drive shaft secured thereto are rotating counterclockwise (CCW). The drive position identified in FIGS. 4 and 5, for example, for each vertically paired set of wings, is determined by the wind direction and located at the 0°-90° quadrant of the rotating assembly 41 that recedes from the oncoming wind due to the rotational motion. Wings III and IV are in the drive position in their respective backstop assembly 44 as the assembly 41 has rotated to the angle at which the wings III and IV are completely transverse to the incident wind, and the backstop assemblies are generally aligned with the quadrants of the solid angle through which the assembly 41 rotates. This orientation guarantees that the wings VII and VIII at the opposed ends of their respective pivot shafts 28B and 29B are rotated completely into the glide position. At the same time the backstop assembly 44 is beginning to transition from the glide position, and the wings V and VI have arrived at the angle where they are poised to expand from their glide disposition.

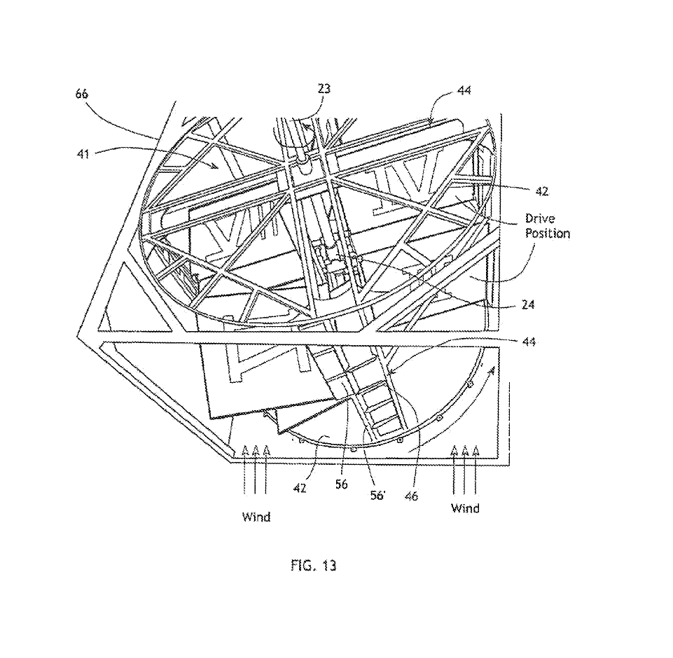

FIG. 13 depicts the same wind turbine as FIG. 12, with the rotating assembly advanced 15° in the rotational drive direction. The wings III and IV are still in the drive position, catching the full brunt of the wind force and pushing the wind turbine to rotate CCW. The wings V and VI are beginning to rotate and diverge from their glide positions, while at the same time their counterparts on the same pivot shafts, wings I and II are rotating out of their drive positions and beginning to move toward their glide positions. The oncoming wind force is caught by the diverging wings V and VI, urging the wings to open further and pushing the progress toward the full engagement of the drive position.

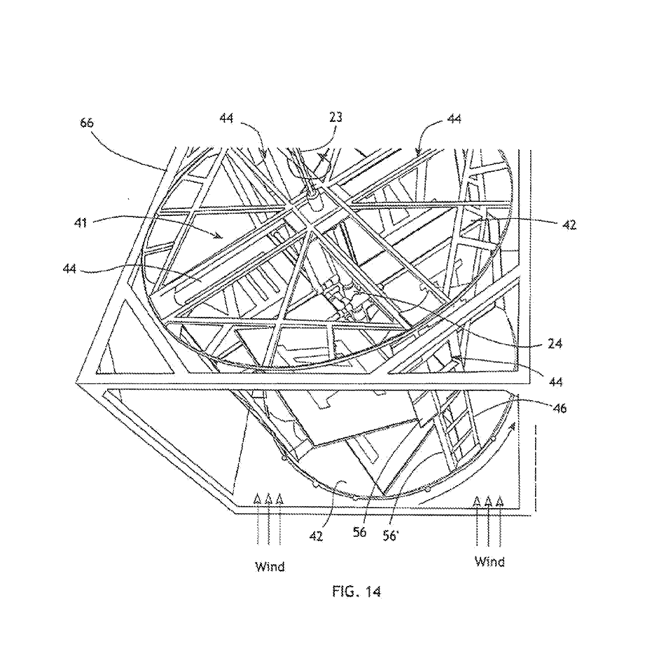

In the view of FIG. 14, the rotating assembly 41 of FIGS. 12-13 has turned a further 15° CCW from FIG. 13. The wings V and VI are opened about halfway from their glide position toward their drive position. The incident wind is not only forcing the wings V and VI to open further, it is deflecting off those wings and creating CCW torque on the rotating assembly 41. Thus the partially open wings are productive even before the drive position is attained. At the same time, the wings III and IV are beginning to rotate out of their drive positions and move toward their glide positions.

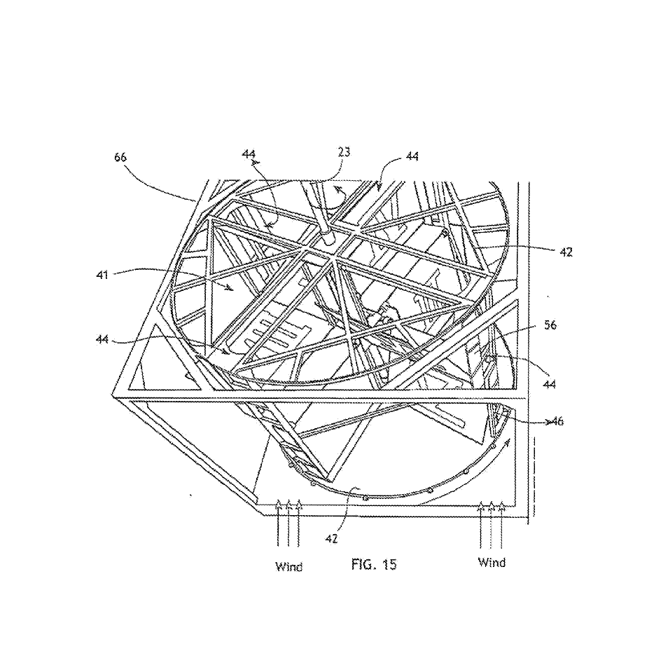

The cycle continues in FIG. 15, in which the assembly 41 has rotated a further 15° from the previous Figure. Wings V and VI are approaching full extension into the drive position and are catching a large fraction of the incident wind, which also determines that their counterparts on their pivot shafts, wings I and II, are approaching full rotation into the glide position. Wings III and IV are rotating further out of the drive position toward the glide position. In the next 15° incremental rotation, wings V and VI will be in the positions of wings III and IV shown in FIG. 12, and the process will begin to reiterate and continue indefinitely, as long as the wind is blowing at the wind turbine.

It should be noted that the paired parallel pivot shafts (26B with 27B, and 28B with 29B) rotate through a 90° angle in a reciprocal manner with each rotation of the rotating assembly 41. Moreover, each of the paired shafts is always rotating in a counter-direction to the other of the pair, so that their moments of rotation are substantially equal and opposite. This factor causes those moments of rotation to effectively cancel each other. In addition, any gyroscopic moments of precession of the pivot shafts are likewise canceled by the paired shafts, so that the cylindrical turbine assembly 41 is dynamically balanced in plural regards.

Thus the wind turbine of the invention may be placed in a wind stream from any direction, and it will begin to turn and establish a rotational velocity commensurate with the wind speed. And although the wind turbine has been described with its axis of rotation extending generally vertically in the Figures, it may be appreciated that the wind turbine may be disposed at any angular orientation, the only requirement being that the axis of rotation 21 is substantially transverse to the wind vector impinging on the turbine. The central drive shaft may be joined to the rotational input of any suitable apparatus or engine, such as an electrical generator, pump, compressor, or the like.

Although the single turbine is a self trimming viable working turbine unit, the fact that the drive position of the wind turbine is the locus of the wind force captured by the wings causing that force to be applied to the central drive shaft almost exclusively on an innate drive side that is diametrically opposed to the glide position of the wings of the wind turbine. This unbalanced force situation may present issues of wobble and wear of the bearings, and the like. Moreover, the inevitable frictional losses between the rotating wind turbine 41 and the bearings and frame create a residual torque applied to the frame 66 and its anchor or mechanical ground.

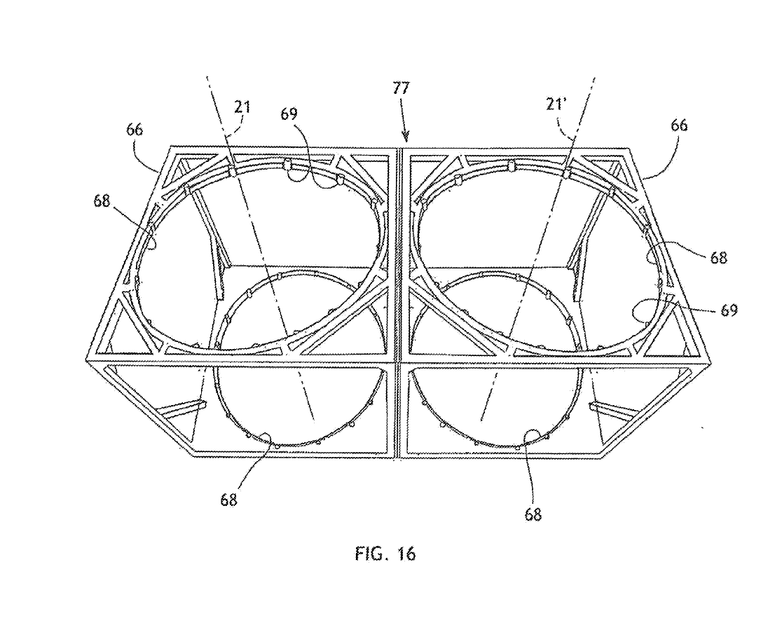

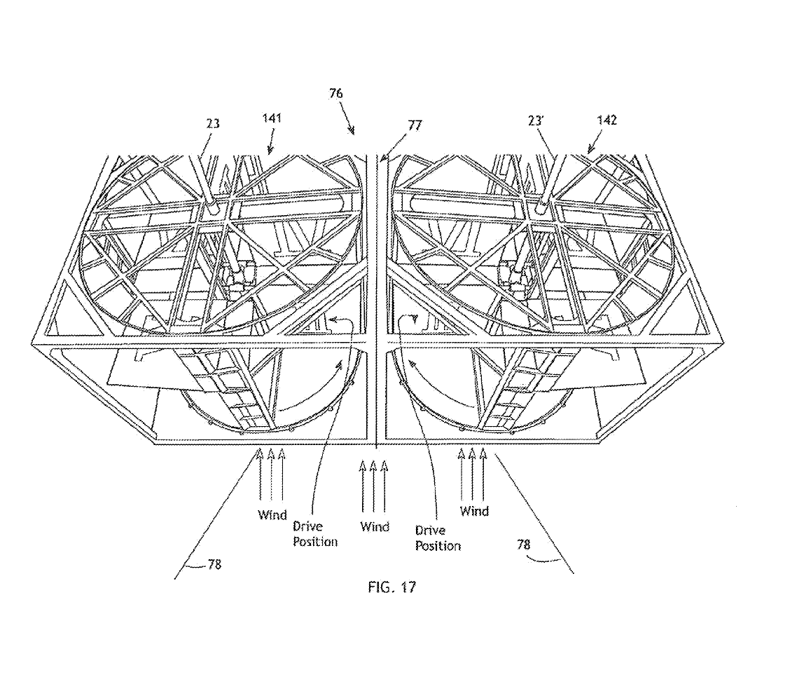

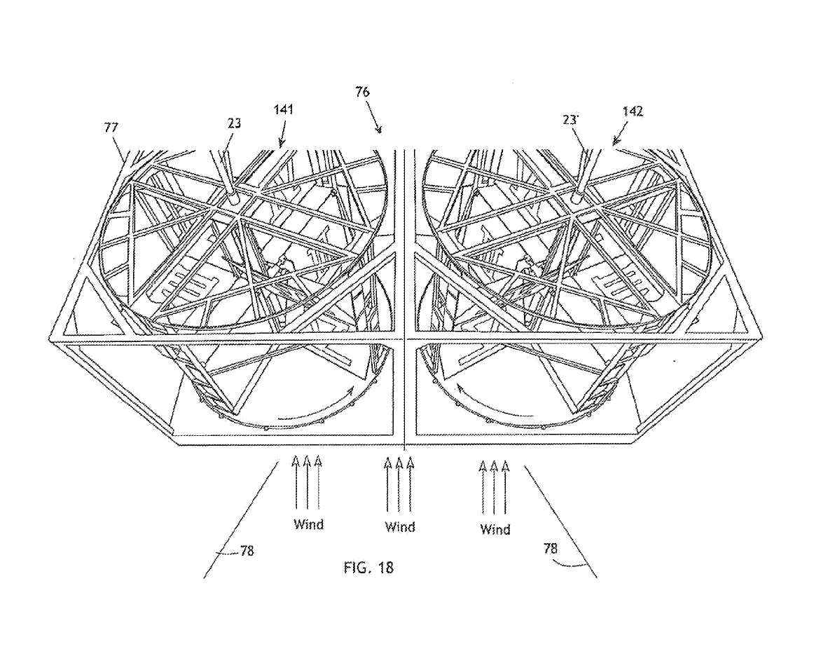

Thus a further aspect of the invention is a twin turbine assembly 76, as shown in FIGS. 16-18, in which the forces experienced by the wind turbines are balanced in mutual equilibrium. A key component of the twin turbine 76 is a twin turbine frame 77, as shown in isolation in FIG. 16. The frame 77 is essentially a pair of housings 66 as described previously, each comprised by an open frame having a rectangular or cubic shape, and supporting a pair of circular supports 68 with optional bearings 69 to support the end assemblies of a pair of rotating wind turbine assemblies 141 and 142, each supported in a respective opening in the housing 77 and aligned with axes 23 and 23′, respectively. Note that the axes 21 and 21′ of the two wind turbines are parallel and spaced as closely together as possible while avoiding interference of the wings of the adjacent wind turbines 141 and 142. A significant feature of this embodiment of the invention is that the two turbines are counter-rotating, as indicated by the motion arrows, so that the residual torque on the frame 76 is essentially equilibrated to zero.

To create a twin turbine, where one turbine is turning clockwise, and the other is turning counter-clockwise, it is not necessary to add or create any additional parts. Rather, in one of the turbines each of the backstop assemblies is merely changed to a position at the other side of the wings it has been engaged with, and the axle and wings are turned around (end for end). In most models this is accomplished by merely turning one turbine over on its opposite side. Thus setting the rotational direction is a trivial task that requires no new components. In this embodiment, one turbine functions in the exact opposite way as the other. Having all parts of both turbines mirror one another's movements creates a symphony of symmetry and balance. The twin turbine model not only eliminates the torque issue, but also dynamically balances each turbine relative to the other.

Furthermore, by rotating the turbines 141 and 142 in the opposite direction to one another, it is possible to locate the drive side (where the drive position of the wings is disposed) of each turbine adjacent to the other in the middle of their common frame structure 77, thus forming an intake area 78 confronting the incident wind that is double the size of a single turbine and thereby doubling energy production. The central drive shafts 23 and 23′ may be connected to any rotational machine input through gears, pulleys, chain drives or any other mechanical expedient known in the art. This allows the turbines to remain synchronized and dynamically balanced each with the other.

With regard to FIG. 19, the twin turbine arrangement of FIGS. 16-18, hereinafter the side-by-side twin turbine 76, may be further enhanced by placing the entire assembly on a rotating support 81 that pivots freely about an axis 80 (the Z axis in FIG. 19). A tail assembly 82 extends from the turbine 76 in the leeward direction, and acts as a weather vane to rotate the support 81 and point the intake opening 78 of the turbine directly into the wind. Thus this apparatus will always track into the wind and generate the maximum amount of power even in changing wind conditions. Furthermore, if the ambient winds become too high and pose a threat to the wind turbine 76, the tail apparatus may be reefed and the support 81 rotated (manually or automatically) so that the intake opening is directed out of the wind and safe from storm winds and the like.

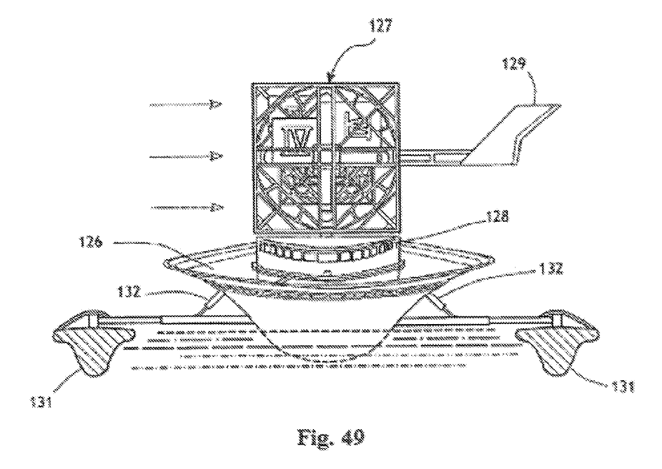

As suggested in FIG. 19 and shown in FIG. 20, the wind-seeking apparatus of FIG. 19 may be provided with a wind foil 84 extending about the windward side of the assembly and tapered in funnel-like fashion to direct incident wind into the intake opening 78. In addition, a nacelle may extend across the opening 78 to split the incoming air stream into two columns that each impact one of the drive positions of the turbines 141 and 142. An additional surface for directing wind into opening 78 is the cylindrical wind foil 84B surrounding the main shaft, in radial offset models seen in FIGS. 19 and 49. These features cause the wind to be concentrated at the intake opening 78 to maximize conversion of wind energy to useful work.

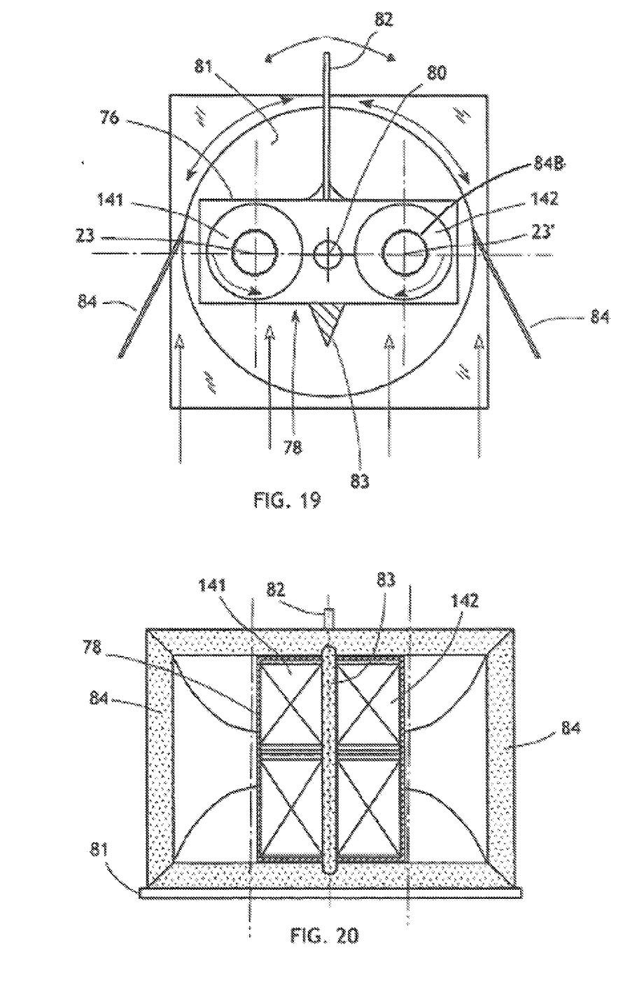

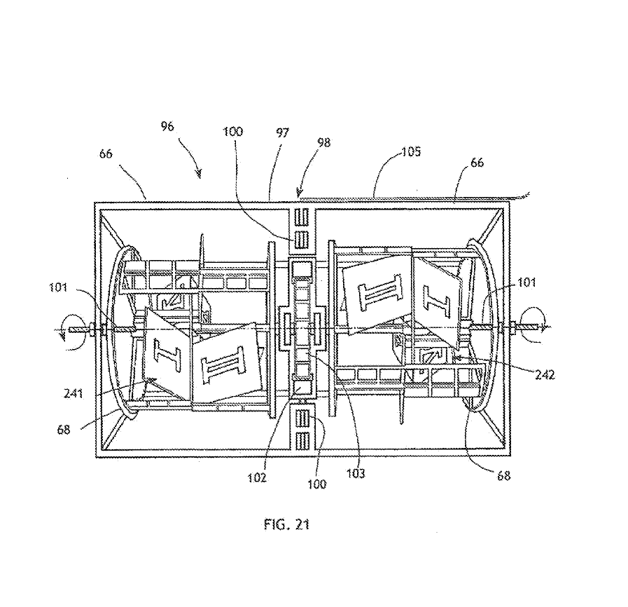

With regard to FIG. 21, a further aspect of the invention is the combination of a pair of wind turbines in a twin turbine end-to-end apparatus 96. A twin turbine frame 97 is comprised essentially of two housings 66 described previously and comprised by an open frame having a rectangular or cubic shape, and supporting a pair of circular supports 68 for a rotating turbine assembly 41. In the apparatus 96 the housings 66 are joined in axially aligned, end-abutting relationship, and two turbine assemblies 241 and 242 are supported in the housings 66 with their central drive shafts aligned. An axle 101 extends axially through the central bore of the tubular central drive shafts 23 of the two turbines, so that each may rotate independently while hewing to a common rotational axis.

Indeed, one of the turbines 241 or 242 is constructed to counter-rotate with the other of the pair, as explained in the previous side-by-side embodiment 76. This involves reversing the backstop assemblies and the pivot shafts so that the turbine turns in the opposite direction, as also described above.

An electrical generator 98 is supported by the frame 97 in a position intermediate the two turbines 241 and 242 and coaxial with those mechanisms. The central drive shaft of turbine 241 is connected to the field assembly 102 of the generator 98, while the counterpart of turbine 242 is connected to the central armature 103 of the same generator 98. The field unit and armature are counter-rotated by the two turbines 241 and 242 as they are turned by passing fluid flow, resulting in a net angular velocity that is twice that of a fixed-field generator. The electrical power thus generated may be picked up by electromagnetic coils 100 and fed through cables 105 extending along the frame 97 to a fixed anchor or similar support arrangement. Alternatively, the power may be picked up by slip rings or brushes or similar mechanisms known in the prior art, and connected to the cables 105.

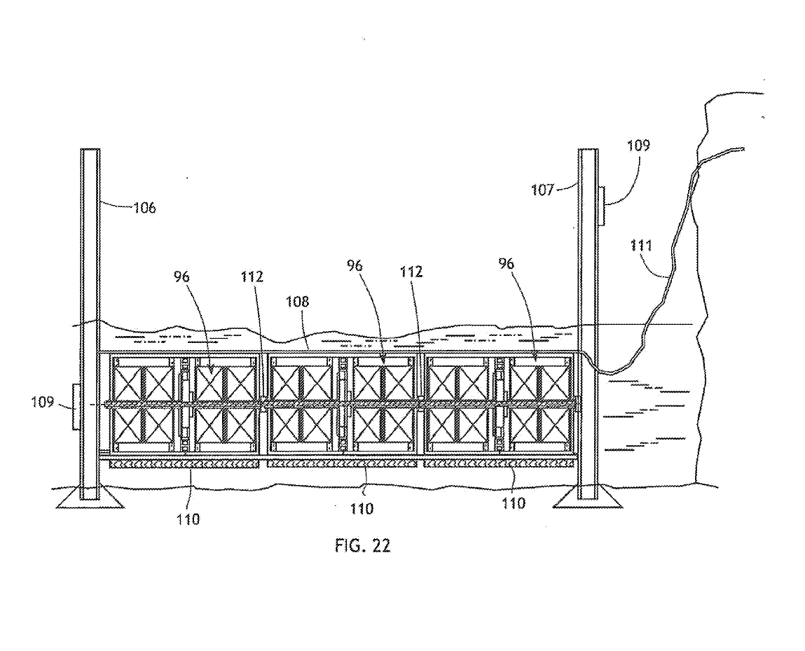

The end-to-end turbine 96 lends itself well to use in generator sites where water flow is extensive, either through tidal flow, river currents, or wave action. With regard to FIG. 22, a pair of stanchions 106 and 107 are anchored in the bottom of the lake, river, or bay, and each stanchion is provided with a vertical track. Lateral supports 108 extend between the stanchions and engage the tracks thereof, and are vertically movable by a motor drive system 109. Secured to the lateral supports 108 is a plurality of turbine assemblies 96, these turbines having been modified for operation in fresh or salt water. Each turbine includes a neutral buoyancy chamber 110 filled with ballast or air to establish a neutral buoyant condition for each turbine. The turbines extend coaxially, and are joined by universal joints 112 which couple the like-rotating ends of the end-to-end turbines, thereby doubling the torque applied to their generators. The universal joints 112 also act to prevent any residual torque along the turbine array.

Each turbine assembly 96 includes two counter-rotating turbines driven by the water flow between the stanchions created by natural forces, and the electricity thus generated is fed through a cable 111 to electricity consuming devices and customers. It may be appreciated that even if the water flow is reversed, as in tidal situations or wave action, the paired turbines will always counter-rotate in their same directions and the electricity generation will continue. Indeed, the turbine assemblies 96, whether used singly or as multiples in axial alignment, are completely self-trimming; that is, the drive position always moves angularly about the central axis so that the wings in their drive position confront the oncoming flow in fully transverse relationship to the flow. In addition, if water conditions (storm waves, tidal surges, and the like) threaten the generating facility, the motor drive system 109 may be activated to pull the wind turbines upwardly on the stanchion tracks and out of the water to avoid damage.

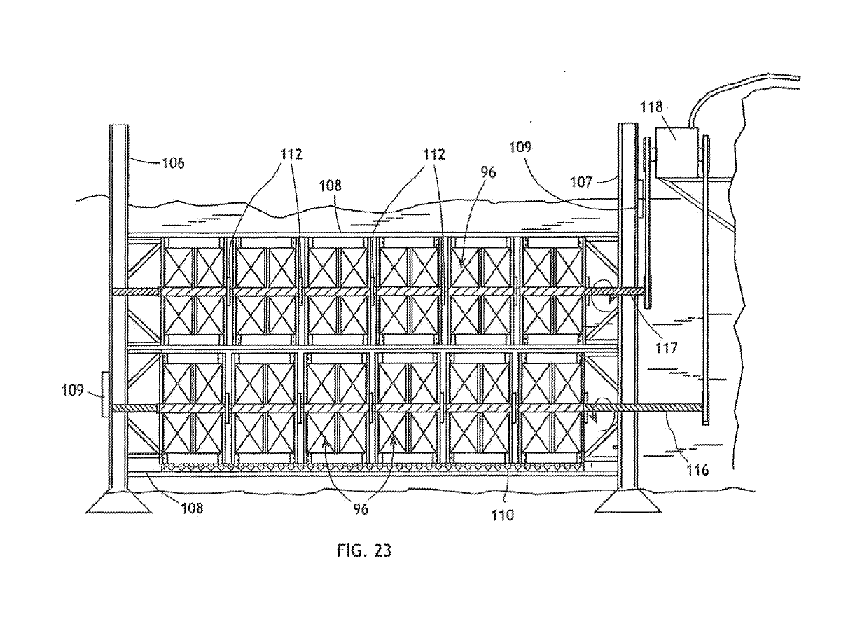

A further embodiment of the turbine 96 driven by flowing water is illustrated in FIG. 23, wherein components similar to those of FIG. 22 are given the same reference numerals. As in the previous embodiment, a pair of stanchions 106 and 107 are anchored in the floor of a body of water, and each stanchion is provided with a vertical track. Lateral supports 108 extend between the stanchions and engage the tracks thereof, and are vertically movable by a motor drive system 109. In this embodiment there are two axially aligned rows of turbine assemblies 96, these turbines likewise having been modified for operation in fresh or salt water. A neutral buoyancy chamber 110 filled with ballast or air to establish a neutral buoyant condition for the turbines is secured to the bottom of the assembly.

In each row, the turbines are set to rotate in the same angular direction, and are joined in series by intermediate universal joints 112 to add the torque along the turbine array. The output is coupled to upper shaft 116 and lower shaft 117, which are mechanically connected to a generator 118 by any suitable mechanical motion transmission. Here the generator 118 is supported above the waterline for easier connections and maintenance. The two shafts 116 and 117 counter-rotate, and are connected to opposed ends of the generator 118, whereby the field assembly and armature of the generator are likewise turned in counter-rotation to double the angular velocity and increase the voltage and power output of the generator. As in the previous embodiment, the drive side of each turbine 96 will change if the water current direction between the stanchions reverses, but the pairings of counter-rotating turbines in both cases enables the water current generator arrangement to continue to operate without requiring any changes to the devices. As before, if storms or wind create hazardous conditions, the system 109 may be activated to raise the entire turbine assembly on the stanchion tracks out of the water to avoid damage.

In both the embodiments of FIGS. 22 and 23, the lateral supports 108 may comprise tubular struts or pipes, or may comprise high strength wire rope or cable spanning the stanchions and maintained under high tension by a standard turnbuckle arrangement or hydraulic or pneumatic actuators. Indeed, a high tension wire rope or cable may be passed through the aligned tubular central drive shafts of the turbines 96 to align and support them directly on their axes. Four or more high tension cables may be extended in a similar manner between the stanchions to pass through the four interior vertices of the frame structures 66 (and optionally other parts as well) to anchor the devices. This arrangement has the advantage of easy assembly and disassembly for maintenance purposes. Also, the neutral buoyancy afforded by chamber(s) 110 in both embodiments serve to minimize the suspended weight and reduce undesirable loading on the cables. In addition, in both embodiments the number of turbines turning in one angular direction is matched by an equal number turning in the opposite direction, so that the net torque on the assembly is zero.

With regard to FIG. 24, the twin turbine concept may be extended by providing two twin turbines in an array that combines the best of the end-to-end and side-to-side embodiments illustrated above. Two end to end models 96 are joined in a four turbine array by linking their outer frames 66 in adjacent, impinging relationships. In this arrangement the counter-balancing torque feature of the side-by-side turbines turning in opposite directions on the two parallel main shafts, and also the end to end turning in opposite directions sharing the same shaft with two generators 98 sandwiched in between doubling the generators' angular velocity.

In general, the turbine construction of this invention exhibits several advantages over other wind turbines. One of the major disadvantages of traditional propeller-type turbines is that these machines cost millions of dollars and, because of their large diameters, they require tall pylons and must be anchored in concrete deep in the ground. Thus they are fixed installations and cannot function during windless days or seasons. In contrast, a wind turbine according to this invention that generates a comparable energy output could be made to be transportable anywhere that the wind happens to be blowing. A turbine may be transported on a truck, either sized to the truck, or much larger than the truck, broken down into smaller component parts, making them transportable on the highway and easily reconstructed. Instead of an investment of millions of dollars staying idle during windless periods, these machines may be moved on the truck bed throughout the year to locations where the wind is blowing, optimizing the return on investment with high yearly energy yields. Unlike traditional propeller turbines, these compact units extract a high percentage of the available energy relative to their operating space. They are slow-moving with extremely high torque.

The wind turbine of the invention is also very scalable from very large installations to very small ones. For example, a collection of miniature turbines can be arranged on a line in a series stretched across a stream for manageable, portable, do-it-yourself, domestic or recreational power generation. Or the turbines can be as large or larger than a ten story building. Since these turbines operate closer to the ground than traditional propeller models that tower in the air, they have a lower visual impact on the skyline. Furthermore, the relatively slow moving turbines of the invention may pose less of a danger to birds as, even 27, without their intake wind foils in place, the glide side is always open, and the drive and transition sides always appear to be obstructed.

A salient feature of the construction of this wind turbine is that all moving parts, because they have equal and opposite counterparts moving in the opposite direction at all times, are vertically and diagonally balanced. Returning to FIGS. 4-7, note that diagonally, wing I is balanced with VI, II is diagonally balanced with V, III with VIII, and IV is diagonally balanced with VII as they are numbered on these illustrations. Obviously, looking vertically, both wings I+II, III+W, V+VI and VII+VIII are balanced.

It may be noted that the wings in this model are of different lengths at axially opposed ends of the wind turbine. This is because the axle housings on the hub are longitudinally offset as described above. Regardless of the different wing size this difference is also symmetrical and dynamically counterbalanced by virtue of this design. The shorter wings on the upper pivot shaft 27B with wings IV and VIII going up are shorter than wings on axles 28B and 29B because they are closer to the upper covered rim but are the same size as wings I and VI that go down on the lowest mounted axle, which are closer to the bottom covered rim of the turbine. These two axles with their same sized wings stay dynamically balanced because each wing is diagonally and vertically opposite in position, size and movement direction to the other. The same relationship applies to pivot shafts even though their wings, being the same size, are slightly longer than the wings of pivot shafts 26B and 27B.

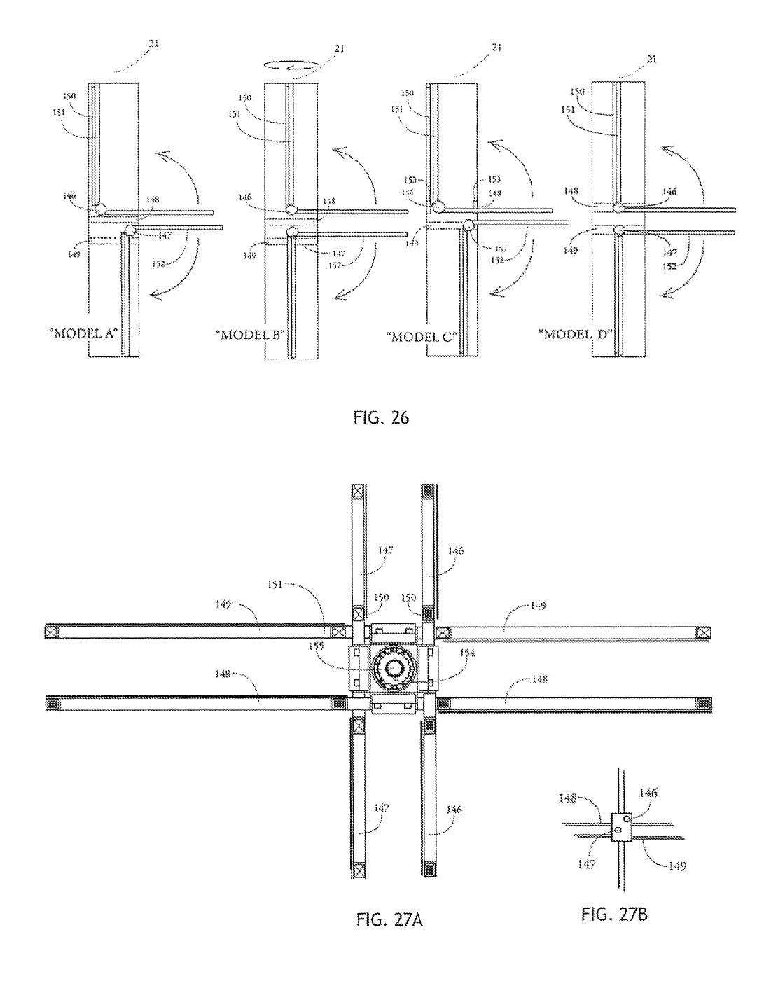

With regard to FIG. 26, there is illustrated the four possible arrangements for supporting the pivot shaft on the hub: “Model A”, “Model B”, “Model C”, and “Model D.” Each of the pivot shafts in the first parallel pair are individually designated as 146 and 147. Each of the pivot shafts in the second parallel pair fixed 90° to the first pair are individually designated as 148 and 149. In the hub design described above, labeled “model A”, both pivot shafts 146 and 147 have axes that are staggered on differing vertical planes relative to the main shaft in its vertical position and offset laterally from the center axis 21 of the main shaft, as are pivot shafts 148 and 149. Note that pivot shaft 148 is disposed directly subjacent to shaft 146, and shaft 149 is directly subjacent to shaft 147, in an interleaved (staggered) arrangement.

In the pivot shaft arrangement of hub “model B”, pivot shafts 146 and 147 have axes that lie in a plane that passes through the axis 21 of the main shaft. Pivot shafts 148 and 149 are interleaved with shafts 146 and 147, as in Model A, but shafts 148 and 149 are also aligned so that their axes lie in a plane that passes through the axis 21 of the main shaft.

Hub Model C is similar to hub Model A in that the pivot shafts 146 and 147 are staggered and horizontally offset from the center axis of the main shaft. However, pivot shafts 148 and 149, although offset like hub Model A, instead of being interleaved, are located in the same plane as shafts 146 and 147, respectively. The hub Model D is a modification of hub Model B with all pivot shafts aligned in planes that intersect the axis 21 and also aligned in respective horizontal planes.

The function of the hub in all designs is to arrange the four pivot shafts around the main shaft, keeping the pivot shaft housings vertically staggered along the main shaft so one wing and pivot shaft will be held at a slightly lower horizontal plane than its parallel counterpart, enabling one wing to tuck under the other in their glide position. There may be many hub design variations that will achieve this objective. The combination of these four hub models in conjunction with application specific turbine models has made possible a variety of modifications to the basic arrangement of the invention.

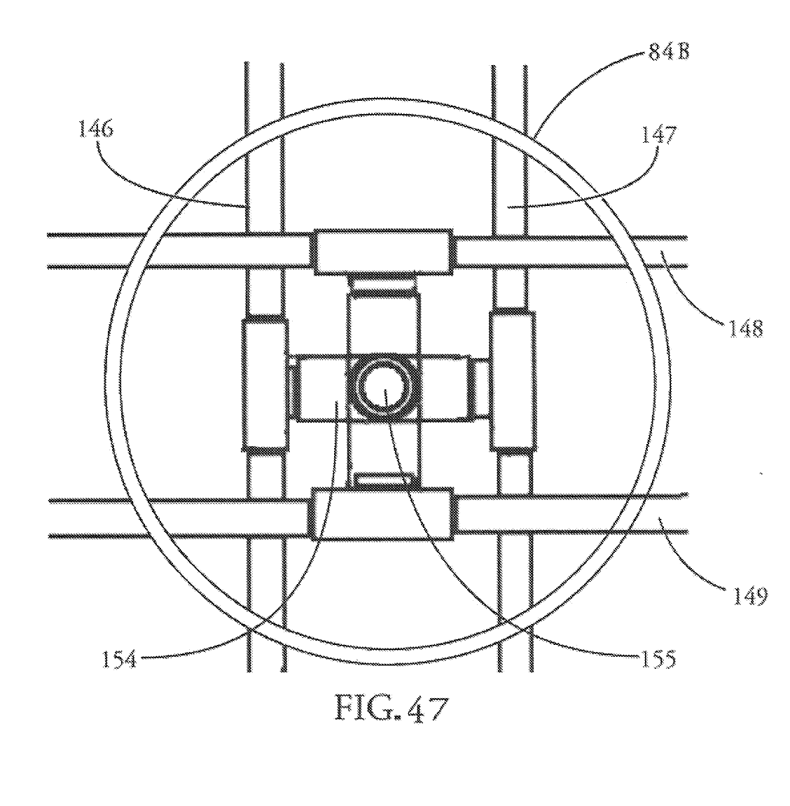

Because the pivot shafts of the original “model A” hub are held in a horizontally diametrically opposed position relative to the main shaft, as shown in FIGS. 27B and 47, the wings on pivot shafts that transition up, move into and out of glide and drive before or after the wings on the pivot shaft that transition down. This spreads the four 90 degree segments of the eight wings into two sets of four offset intermittent 90 degree segments. Thus the turbine will engage in forward movement at lower wind speeds with the added advantage of spreading the 90 degree segments of the two wings into two slightly offset 90 degree segments. For use in a variety of applications, the profile of the original hub embodiment can be streamlined, simplified and strengthened. FIG. 27A shows the first modification, called the Streamlined Hub. This hub is a “model A” design like the original hub with the main shaft 154 housing a stationary axle 155. Each pair of pivot shafts are in the same offset and staggered arrangement as in the original “model A” design, but are brought together as close as possible so as not to compromise the structural integrity of the main shaft's housing the stationary axle that runs vertically down the center of the main shaft. This modification streamlines the hub profile and thus can increase its strength and further minimize drag. Note: exposed backstop assemblies 150 in this top-view are rendered as solid black rectangles.

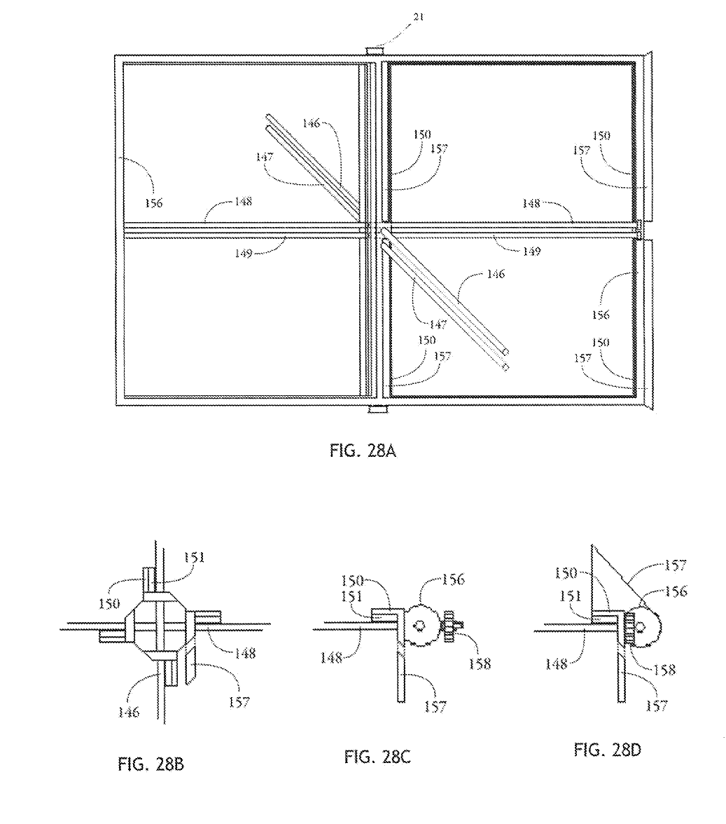

With reference to FIG. 28A there is shown a model B modification in which the two pairs of pivot shafts 146-147, and 148-149 are vertically spaced along the main shaft but in line with the center axis 21 of the main shaft. This modification eliminates the stationary axle 155 because the pivot shafts are in line with the center axis of the main shaft where this axle otherwise would be located. Having a central stationary axle is a vital design element for many applications. However there are other applications not needing this feature. In this design the two types of pivot shafts, from now on referred to as type “U”146 and 148 (with wings transitioning up), and type “D” 147 and 149 (with wings transitioning down) are still perpendicularly and vertically staggered down the main shaft, but are all in line with the center vertical axis of the main shaft.

With each type of pivot shaft no longer laterally offset, as in the earlier embodiment, but in line with the center vertical plane of the main shaft, the support structure at the opposed outer ends of the pivot shafts to the turbine assembly can be reduced in complexity from a ladder like structure, such as component 46 of FIG. 14, to a round or square rod-like side structure 156 of FIG. 28A. Because all wings pivot from the center of the main shaft, and can be attached directly to the main shaft 154, the side support structure 156, and the upper and lower surfaces of the turbine assembly, such as component 42 of FIG. 14. In the top view of FIG. 28B there is shown the optional wind/water fairing panels 157, and the cushion 151 on the backstop assembly. The optional drive gears 158 on the side support structure 156 are shown in FIGS. 28C and 28D.

With regard to FIGS. 29A and 29B, the fact that one wing tucks under its superjacent companion in their horizontal glide positions offers a space therebetween to run a brace 159 from the one side structure to the other; that is, the brace 159 extends intermediately of each of the pair of horizontally extended wings and spans the distance between adjacent frames 46. Besides serving as a brace strengthening the turbine assembly, a cushion 151 added to the top and bottom of brace 159 (not shown here) serves as a stopping mechanism for each pair of wings extended in their horizontal glide position. The brace 159 is also shown although not mentioned or enumerated in the original application in FIG. 14.

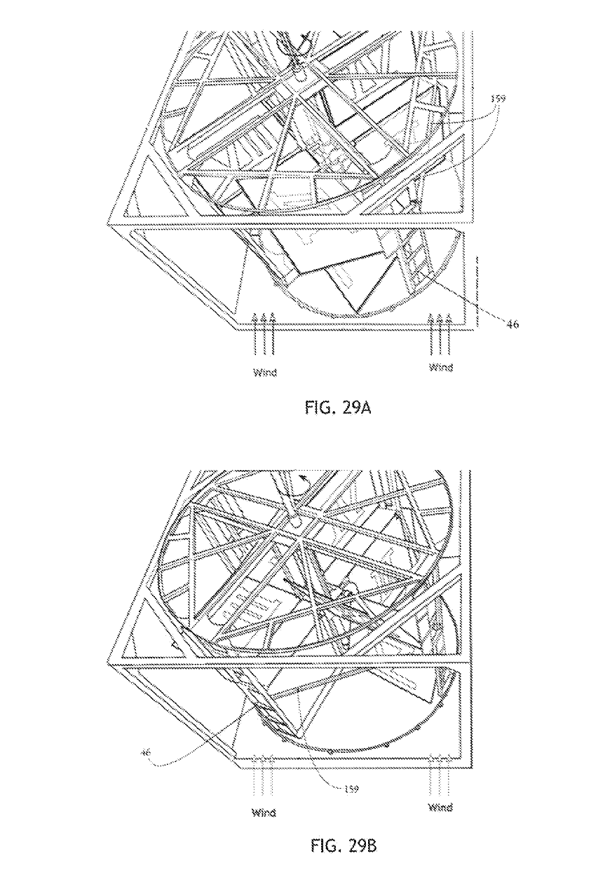

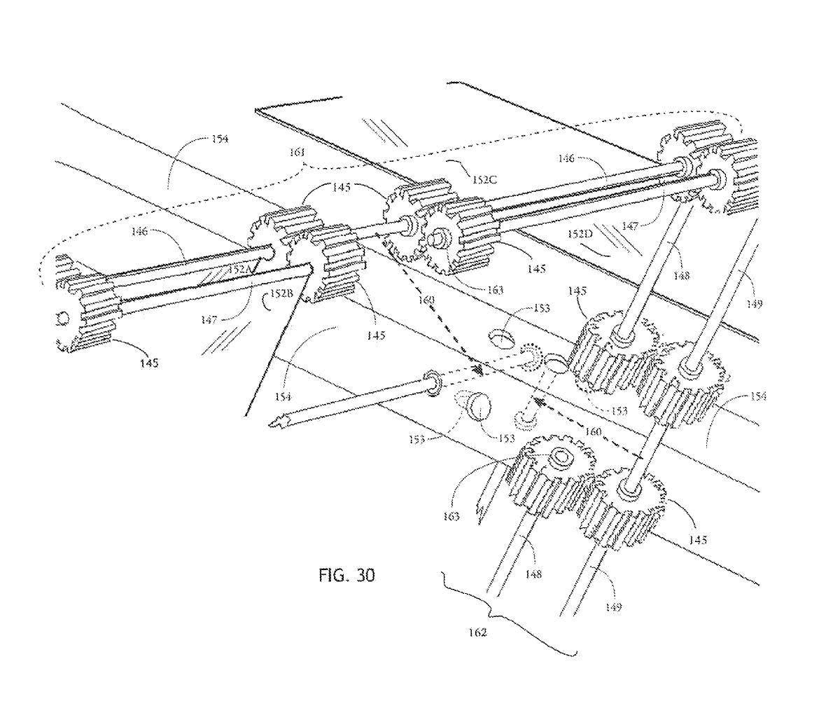

With regard to FIG. 30, a further modification of the Model B arrangement is similar to the embodiment of FIGS. 28A-28D, except for the addition of gears to connect the pivot shafts. This embodiment's side structure design, backstop and fairing panel mounting are very similar to FIGS. 28A-28D, having the same model B pivot shaft and hub arrangement. The changes in this model relate to wing placement, the consolidation of the pivot shafts into two independently operating pivot shaft assemblies 161 and 162 and the adding of gears to the pivot shafts 146-149. These gears connect each type U (up) 146 or 148 pivot shaft with a type D down pivot shaft 147 or 149 so that the four pivot shafts form two separate, independently operating pivot shaft assemblies 161 and 162.

As seen in FIG. 30, each pivot shaft assembly 161 and 162 has one driving pivot shaft and one riding pivot shaft. In assembly 161 the driving shaft 146 drives the riding shafts 147 and in the other assembly, the driving shaft 149 drives the riding shafts 148. In this embodiment, in one pivot shaft assembly the driving shaft is a type U and in the other pivot shaft assembly the driving shaft is a type D. The driving pivot shafts extend diametrically through the main shaft, whereas the riding shafts do not. The riding shafts are mounted on the main shaft with recessed roller bearings 163.

Thus in this embodiment in assembly 161 the Type U shaft 146 doing the driving runs perpendicularly through the main shaft 154 as its two respective rider shafts 147 are supported by a bearing in housing 153 supported on the body of the main shaft. In assembly 162 the type D shaft 149 does the driving and its rider shafts 148 are supported by a bearing in housing 153 on the body of the main shaft. Each independent pivot assembly in this example has four driving gears 145 on its respective driving pivot shaft 146 or 149, each driving a pair of riding pivot shafts 147 or 148 having two similar gears 145 each that are adapted to mesh together.

Because the driving pivot shafts 146 and 149 are oriented perpendicular to one another, and since their respective rider shafts 147 and 148 do not extend through the main shaft, the driving shaft of one assembly and the perpendicular riding shaft of the other assembly can be placed on the main shaft on the same horizontal plane. As shown in assembly 161 the driving shaft 146 traverses the main shaft 154 through housing 160 and the rider shaft 147 and end bearing 163 are placed in the recessed housing 153 in the body of the main shaft. With this feature all wings can be the exact same size and shape and emanate out of the relative center of the turbine' cylindrical volume.

Because the gears 145 of the driving shaft are engaged with the gears 145 of the pivot shafts, all gears of each independent shaft move in unison. The driving pivot shaft gears naturally turn the riding pivot shafts gears in the opposite direction. Because all four wings 152A-D are attached to their respective pivot shafts 146-149, the two wings transitioning down are fully counterbalanced by the two wings that are transitioning up. Instead of the wings going down only having a balanced equilibrium at 45° as before, now all wings are completely counterbalanced throughout their angular excursions. Although not shown in FIG. 30 the exterior gears like those of the next two models may be recessed into the body of the main shaft.

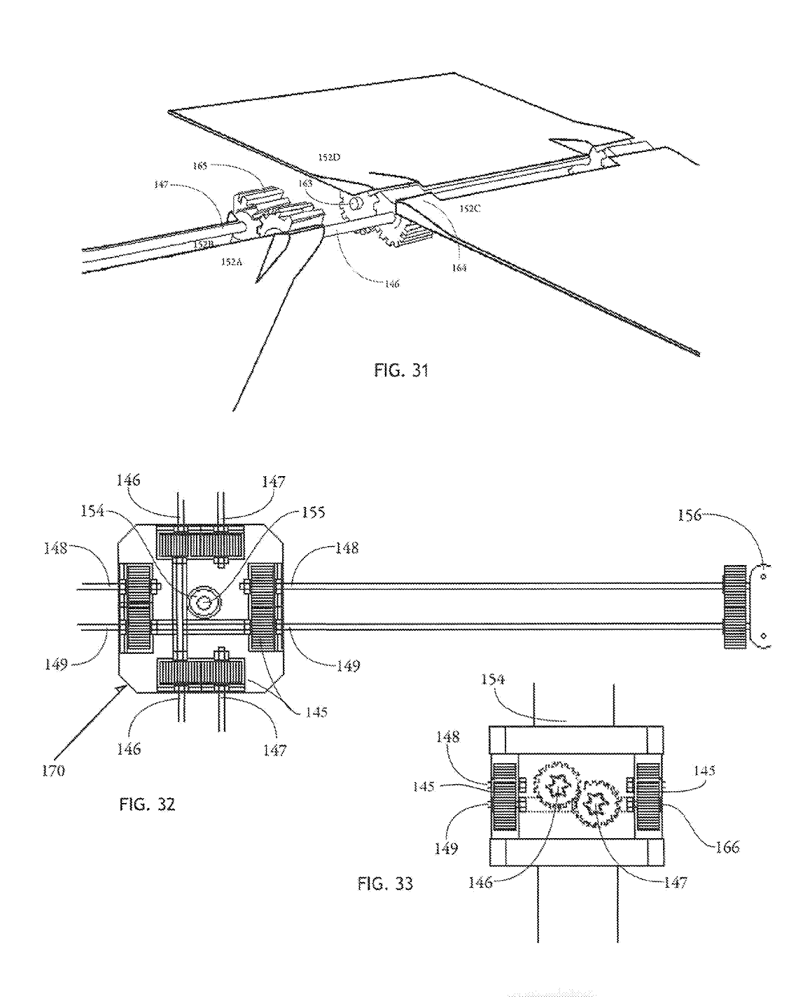

In some models it is desirable to leave all the teeth on the gears 145, which may prove to be less expensive to manufacture. Since each pivot shaft and its corresponding wings never pivot more than 90°, over half of the teeth on the gears are never used. As seen in FIG. 31, when desired the unused teeth can be eliminated to reduce the gear's profile and drag. Wing gear covers can then be aerodynamically molded over the reduced gears, component 164.

With regard to FIGS. 32 and 33, there is shown a further development of model C of FIG. 26. Because the driver shafts of each pivot shaft assembly are offset from the central axis 21 of the main shaft, the interior of the hollow main shaft is unobstructed. Therefore, it is possible in both models to extend a stationary axle 155 through the center axis of the main shaft. In this embodiment the pivot gears 145 are recessed into the body of the main shaft 154 and/or side structure of the turbine assembly. In this embodiment the wings of each of the two pivot shaft assemblies move in unison.

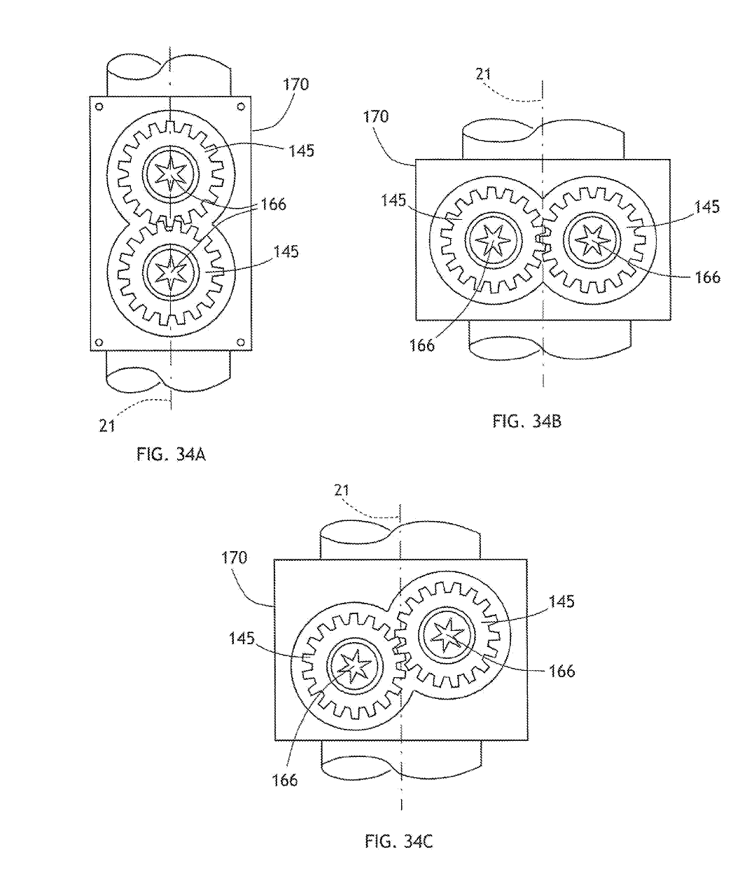

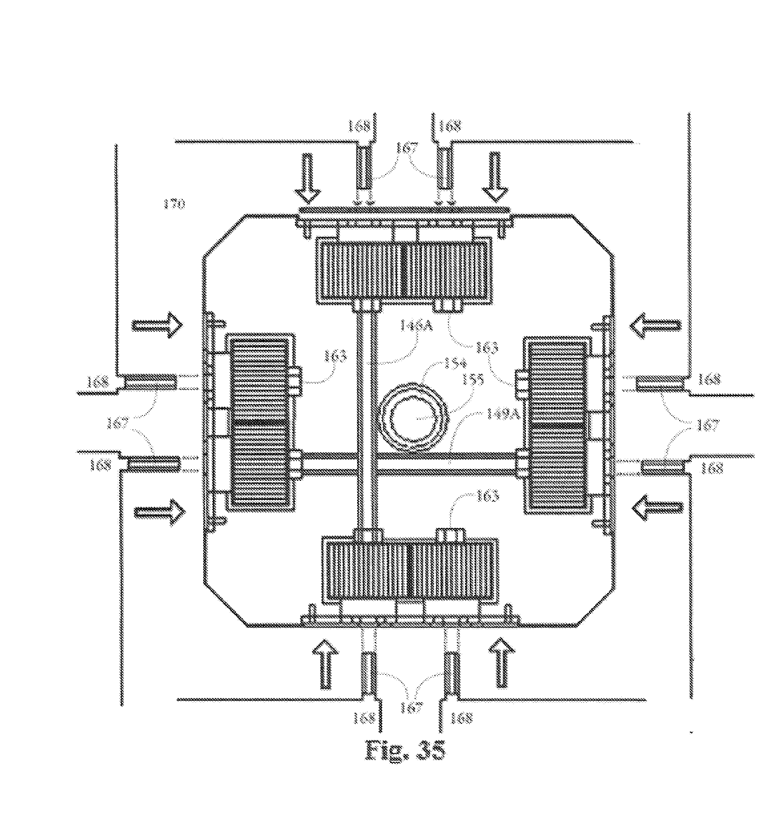

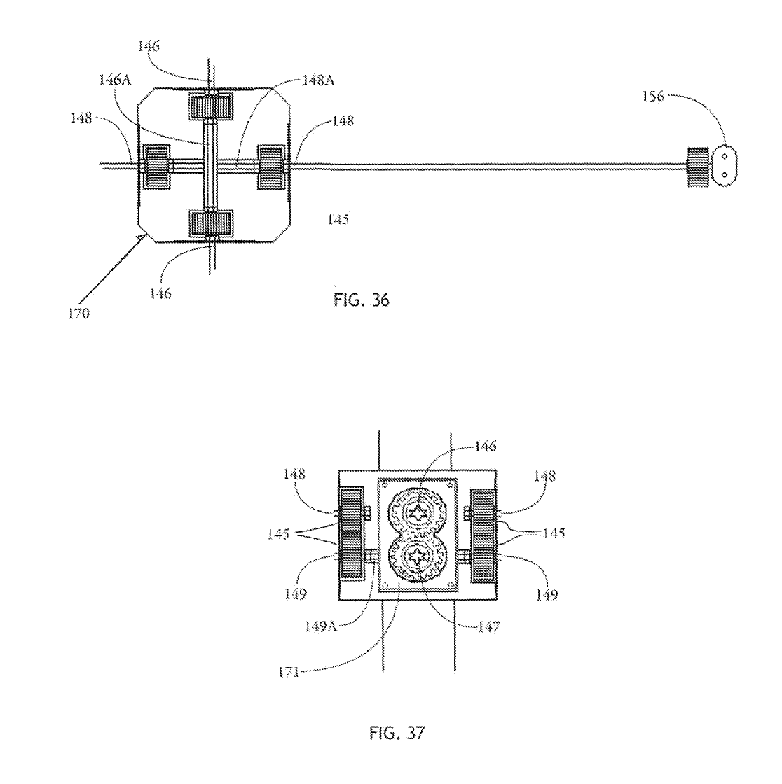

For manufacturing, assembly, maintenance, standardization of parts, parts removal and replacement, field repair purposes, etc, this embodiment is constructed with a separate unified hub transmission 170, as shown in FIG. 32. With regard to FIG. 34A, the pivot shafts are disposed in vertical alignment with the axis 21 of the main shaft as in Model D and, accordingly, the meshing pair of gears 145 and their spline sockets 166 are centered in a plane that intersects the axis 21. However, the pivot shafts may be aligned in a common plane that is perpendicular to the axis 21, as shown in FIG. 34B, and the gears 145 and their spline sockets 166 are laterally spaced apart in symmetrical relationship to the axis 21. With regard to FIG. 34C, when the pivot shafts are vertically staggered along the axis 21, as in Model C of FIG. 26, the gears 145 are likewise offset vertically along the axis 21 and spaced laterally apart in symmetry to the axis 21.

As shown in FIG. 35, both driving shafts 146 and 149 each be formed as three separate sections. The central sections 146A and 149A are located within the main shaft's transmission 170 and the other two identical sections are supporting the wings 146B and 149B. The wings and splined pivot shaft 149B are also joined into one unit, assembly 168. With sockets 166 placed at the end of 146A and 149A and splines 167 made at the ends of all pivot shaft wing assemblies, the wings can be easily removed as arrows indicate in FIG. 35.

Using mechanical transmission arrangements known in the prior art, the two sets of wings on each pivot shaft assembly may be linked together to move in unison through their natural drive, transition, and glide cycles, always staying synchronized with each other. In this model all four wings fixed to each pivot shaft assembly consequently would “flap” together, the two wings on the horizontal glide side close as the two wings on the drive side open and visa versa. This would happen with four wings in each turbine assembly every 90° of forward movement. In turbulent operating conditions the synchronicity of this design offers optimum performance, maintaining balanced wind and water intake and discharge.

The recessed transmission within the main shaft can be incorporated within various pivot shaft layout configurations as seen in FIG. 26 with, for example, two separate driving pivot assemblies as in FIG. 32. One advantage of the model D design is that the pivot shafts are not vertically offset from axis 21 and emanate out of the relative center of the turbine assembly. Therefore all wing assembly parts are the exact same size and easier to mass produce and fabricate. A limitation of this simplified model D hub is that the centered position of the pivot shafts does not allow a stationary main axle to go through the center of the rotating turbine. Other more complicated model D transmission designs do allow room for the central axle using traditional transmission gearing methods.

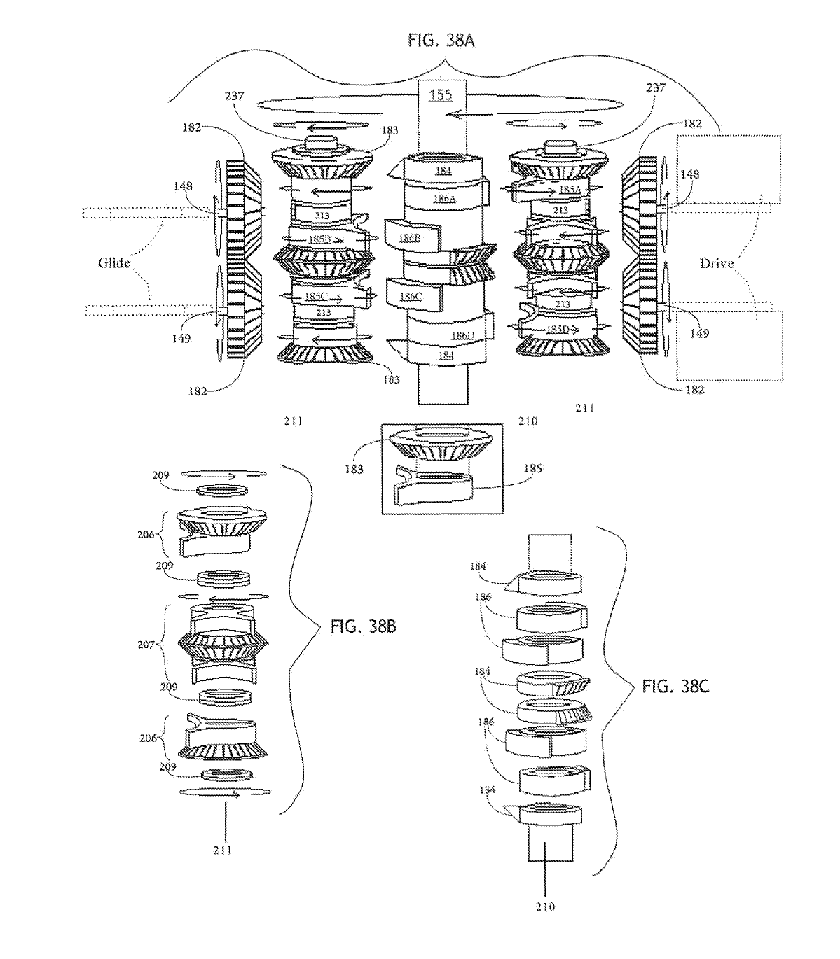

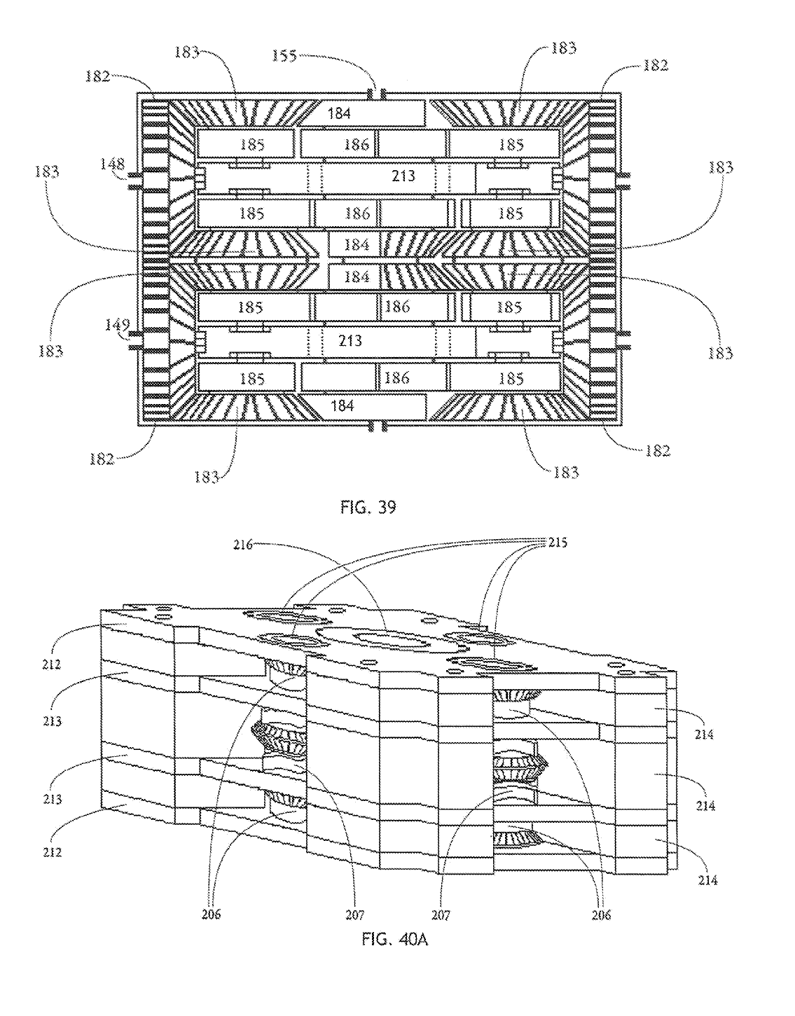

FIGS. 38A-38C and 39 illustrate the fact that all four pivot shafts can be geared together to move in unison, mechanically regulating the drive and glide cycles. We call transmissions with this feature “Quadra drive Transmissions.” This embodiment is termed the sun geared timing transmission and has a Model D hub configuration (as seen in FIG. 26). The advantage of the sun geared timing transmission is that the wings in their drive and glide positions, instead of only being passively moved into and held in position by the fluid current, are actively moved into and held in position by a geared timing and locking mechanism, as seen in exploded views of FIG. 38A-38C, that mechanically replicates the natural movement generated in wind and water in optimum conditions. This positively directed geared movement mirroring the natural passive movement generated by the current may maximize and stabilize energy capture by maintaining optimum positioning in both pairs of stationary and transitional cycles even in turbulent conditions. This ensures that the wings will be locked into their ideal position to confront the fluid flow for 90° of drive, while their sister wings are locked into their ideal glide position to pass through the fluid current with minimum drag for 90° of glide. This may reduce any inefficiencies associated with friction, fluttering or floatation, and help ensure full engagement at higher R.P.M.

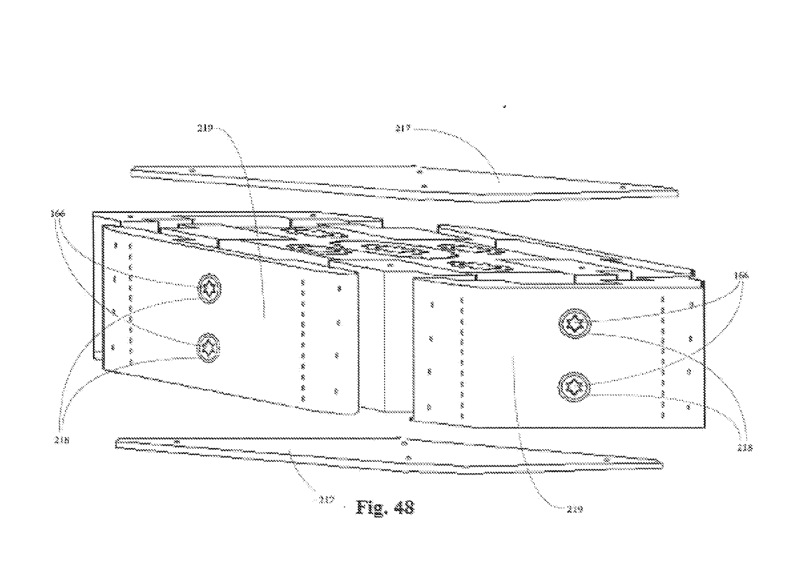

The second major advantage of this design is the reduction of production, maintenance, and transportation costs. Instead of the pivot shafts extending through the main shaft or transmission, wings and splined pivot shafts can be manufactured as one unit that connects to the matching socket 166 (as seen in FIGS. 34 and 48) on the exterior sides of the transmission. This has the production and cost-saving advantage of fabricating eight identical wing and splined pivot shaft units, allowing easy removal and replacement of wing/pivot shaft units in the shop or field, or for the purposes of transportation.

FIG. 38A illustrates the form, function and timing of the transmission as it positions the gears and slider locks through their rotational movement, regulating the four 90° segments of drive, transdrive, glide, and transglide. The fused stationary sun gears 210 are connected to the turbine's stationary main axle 155, around which rotate four assemblies of planetary gear assemblies 211, each of which engage a respective beveled pinion gear combination 182. Each beveled pinion gear is joined axially to a respective pivot shaft and its respective wing. In FIG. 38A the stationary center gear consists of axially stacked combinations of beveled gears 184 with 270° of teeth removed, and male slider locks 186 fused together into one stationary sun gear unit 210, held in place by stationary axle 155.

As seen in the box at the center bottom of FIG. 38A, beveled gear 183 and female slider lock 185 are an example of a planetary gear and lock used in the gear assemblies. These gears and locks are fused together in two different stacked combinations, forming gear lock clusters 206 and 207, as shown in FIG. 38B. Gear lock cluster 206 is created by fusing one 183 gear and one 185 lock together, and gear lock cluster 207 is created by fusing two 183 gears and two 185 locks together. Each planetary gear assembly is comprised of one gear lock cluster 207 and two gear lock clusters 206. The clusters 206 are axially aligned and spaced apart to secure therebetween the cluster 207, with roller bearings 209 placed between the clusters, forming three independently rotating gear clusters. The clusters 206 and 207 are stacked on axle 237 for independent rotation thereabout. The planetary clusters 211 engage and rotate the beveled and pinion gear combinations 182 on pivot shafts 148 and 149. The other two pivot shafts 146 and 147 and their planetary gear assemblies are exactly the same in every respect except in their perpendicular placement relative to 148 and 149. and are not shown for purposes of clarity. In FIG. 38A, the fluid flow incident on the apparatus is engaging the wings to propel the entire turbine assembly and transmission in a clockwise motion (as indicated by the large arrow circling the top of the illustration).

As seen in FIG. 38A, pivots shafts 148 and 149 and associated planetary gears have just completed their 90 degrees of drive and glide. The wings on the left side of the illustration are in the glide position, and the wings on the right side are in the drive position, as propelled by a fluid flow extending in the Z axis upward from the plane of the drawing. The positions of the wings are mechanically locked by the engagement of the locking gears. Proceeding from the top, the first female slider lock 185A on the right planetary stack is held in place by complementary engagement with the first male slider lock 186 on the stationary sun stack. The second female slider lock 185B on the left planetary stack is held in place by a complementary engagement with the second male slider lock 186B on the stationary sun stack. The third female slider lock 185C on the left planetary stack is held in place by complementary engagement with the third male slider lock 186C on the stationary sun stack. And the fourth female slider lock 185D on the right planetary stack is held in place by complementary engagement with the fourth male slider lock 186D on the stationary sun stack. Note that each of these four engaged female slider locks in turn have been oriented so their concave female locking surfaces come into contact with the stationary sun gear convex male locking surfaces throughout this rotational segment. The other four female slider locks are facing the direction of the turbine's rotational movement, and are not engaged.

As shown in FIG. 38A, because of the planetary gears' relative position to the stationary sun gear 184, the gears connected to pivot shafts 148 and 149 are just about to enter into their 90° of transitional movement. The wings on the left side of the drawing will transition open from their glide to drive positions, as the wings on the right will transition closed from their drive to glide positions. Even without this timing transmission, this transitional movement would naturally be generated by the fluid flow passing the apparatus. However, here the transition will be replicated by a gearing mechanism that synchronizes its motion with the turbine's naturally occurring four 90-degree sequences.

Starting with the first 90° of transitional movement both beveled gears 183 on the top and the bottom of the left planetary assembly 211 will engage with the teeth of the top and bottom 90° beveled gears 184 on the stationary sun assembly 210, causing both gears 183 to spin in a clockwise motion. These gears will engage with the beveled teeth of both gears 182 on pivot shafts 148 and 149, which simultaneously engage with each other, rotating the pivot shafts and causing the wings to open into their drive position. Gears 182 also cause the double beveled left planetary gears 183 to rotate in a counter-clockwise motion. Note: planetary gears are free to counter-rotate in respect to one another since there are no teeth on 270° of gear 184 on the stationary sun assembly, which allows for this free counter-rotational movement. As the planetary gears are turned, the orientation of their female locking components freely rotates 90°. The male slider locks of the sun gear assembly are disengaged from the female slider locks to allow 90° of space for this freely rotating movement.

Note that the right planetary assembly has an identical gearing relationship with the sun gear but carries out its sequences intermittently in the same exact transition and locking order. One consequence of this design is that the two 90° beveled gears 183 in the middle of the sun gear assembly are always responsible for closing all wings into their glide position, while the other two beveled sun gears on the top and bottom are always responsible for opening all wings into their drive position.

This rotational movement of each planetary assembly with its sequence of transdrive, locked drive, transglide and locked glide comprises the 360° cycle of rotational motion about the main shaft. However, it is important to note that planetary gears do not rotate 360° about their planetary axes, but rather rotate 90° reciprocally in a motion that minors that of the wings. Planetary gears running pivot shafts 146 and 147 operate in the exact same manner as shafts 148 and 149, transitioning 90° in every 180° excursion and locking 90° in every other 180° excursion but at opposite 90° intervals to one another.

Pivot shafts 146 and 147 (not shown) have an identical gearing relationship to shafts 148 and 149, but carry out their intermittent movement offset 90° relative to the main shaft.

With regard to FIG. 39, there is shown a cross-sectional elevation that cuts directly through the axis of two planetary assemblies and the stationary sun gear. It shows the positioning of gears and locks, how they engage, and how the gear assemblies are separated and held in place by the bearing blocks 187.

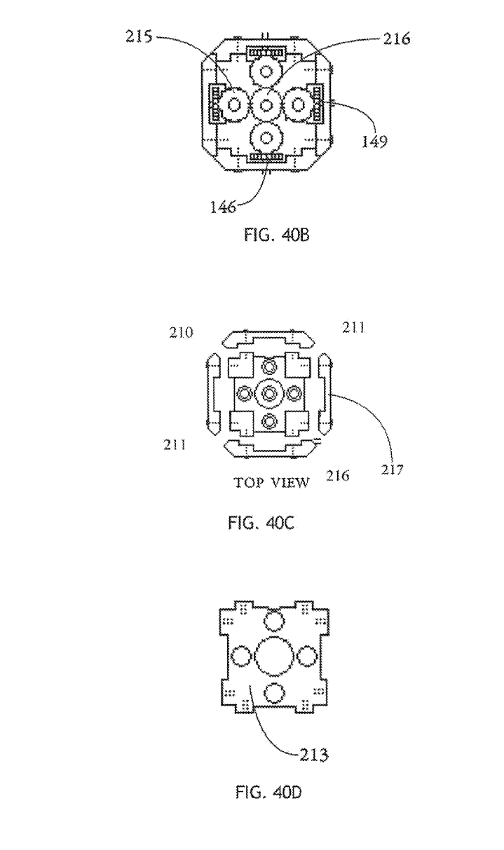

Referring to FIG. 40A there is shown a three dimensional side view of the transmission of FIGS. 38-39, showing how the four planetary assemblies and specifically the individual gear clusters 206 and 207 are situated around the stationary main shaft inside of the transmission. With further regard to FIGS. 40B-40D, the transmission provides a main shaft bearing 216, planetary bearings 215, and spacer blocks 214 as well as the inner and outer bearing housing plates 213 and 212 which comprise the structure that houses all moving parts within the transmission.

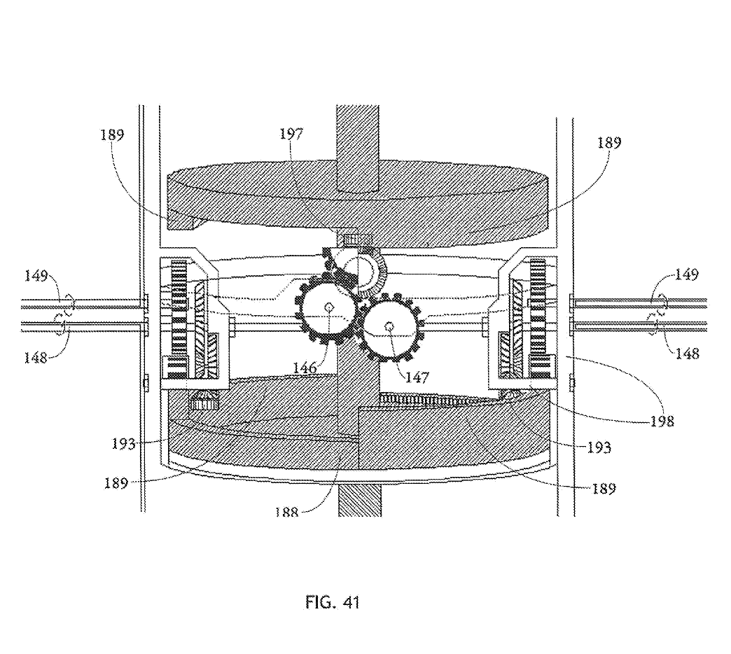

FIG. 41 features the entire Ring Gear Timing Transmission complete with the stationary ring assembly 188, the gearbox and housing 198, and the gears that convey the timed motion to the pivot shafts 146, 147, 148 and 149. Although the mechanics of this transmission are quite different, primarily its functions and advantages are identical to the Sun Gear Timing Transmission featured in FIG. 39 except in the following respects. First, instead of having a Model D hub as in the Sun Gear Timing Transmission, it has a Model C hub configuration (see FIG. 26); and, second, the driver shafts of each pivot shaft assembly traverse through the transmission. This continuous pivot shaft has several structural advantages and may comprise a more robust gear design. In this design both pivot shaft assemblies 161 and 162 (FIG. 30) and their eight wings are actively moved into position by the interaction of their two respective gear assemblies also mechanically replicating the natural movement generated in optimum conditions.

As seen in FIG. 43, this stationary assembly 188 is fixed to the stationary main axle 155. The stationary assembly 188 consists of identical upper and lower cylindrical structures that surround the rotating gear assemblies, with ninety degrees of ring gearing running around the inner rim of each cylinder. These cylindrical structures are held apart and fused to the stationary main axle. Each of these cylinders are divided into four quarter sections that regulate the ninety degree movement of gears and locks circling them.

Each cylinder runs the 90° sequences of each pivot shaft assembly with two opposite-facing 90° locking quadrants and a geared transitional quadrant that intermittently engages between the locked segments. This geared transition quadrant consists of an interior-facing quartered ring gear 190 that regulates the transitional movement going into and out of drive and glide of each respective pivot shaft assembly. Each ring gear 190 runs the pinion gear 193 that runs the gearbox 198 that in turn moves their respective pivot shaft assemblies, in this case, as mentioned, into drive position. The next 90° quadrant of each cylinder is the first male slider lock 189 that locks the wings into ninety degrees of drive by interacting with female slider lock 197. The next 90° quadrant 191 is reduced to avoid all contact with either the pinion gears or male slider locks, which allows for counter-rotation of the adjacent pinion gears so the wings can transition into their glide position. Consequently the pinion gears on the opposite pivot shaft assembly can freely engage in their 90° transition into drive. The last of the four 90° quadrants on the cylinder comprises the second male slider lock 189 that is identical in form and function to the first slider lock, but instead of locking the wings into drive, it locks them into glide.

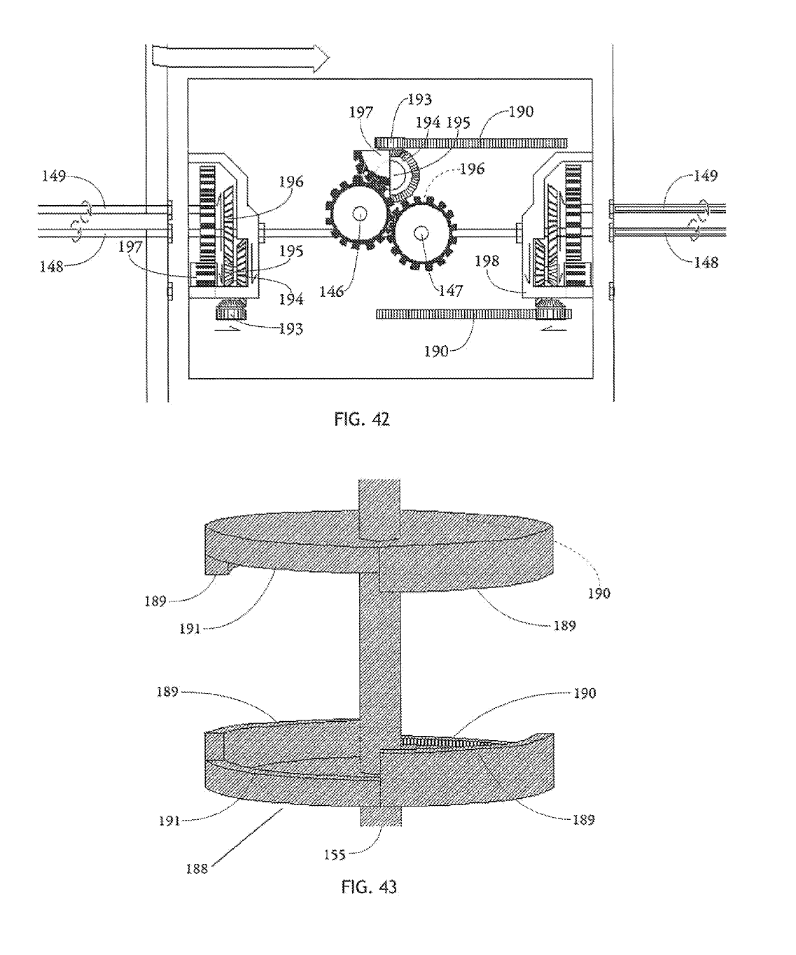

FIG. 42 illustrates the moving gears and female locks of this assembly without the visual obstruction of the housing and stationary ring assembly 188. Combination beveled and pinion gear 193 turns when rotationally engaging with quartered ring gear 190. Pinion gear 193 turns the large beveled gear 194, which is fixed in combination with a small beveled gear 195. This turns a large primary beveled gear 196 fixed to the axle of the driver shaft 148, that also runs the pivot-shaft-to-pinion gear train unit 198 running the sister wings on the opposite side of the turbine. Since the other pivot-shaft-to-pinion gear train unit is on the opposite side, the gears naturally counter-rotate, causing all four wings on the respective pivot shaft assembly to work in tandem.

Because the wing driver gear only rotates one quarter of a turn, an increased gear ratio is needed to turn the small pinion driver gear so it will travel the longer ninety degree distance of the ringed gear section. This is achieved through a series of gears. This pivot-shaft-to-pinion-gear train unit 198 consists of gears with a ratio that allows the pinion gear to rotate four times as it passes along the 90° of ring gear, which causes the secondary gears to turn once, which in turn causes the primary gear and wings to rotate one quarter of a turn. This may allow for less friction and stress on the teeth of the gear and may prove to be a more robust transmission than the Sun Gear model. Note: this illustration shows both of the two gear train units for pivot shafts 148 and 149, but for pivot shafts 146 and 147, only one gear train unit, in the upper middle of FIG. 42, is shown. This shown gear train unit, like its hidden sister behind it, is oriented upwards to engage with the upper cylinder of the stationary ring assembly 188, but is otherwise constructed identically in form and function to the other gear train units.

As seen in both FIGS. 41 and 42, also connected with the pivot shaft gears, the dual female slider lock 197 slides along the 90° male slider lock ring segment 189 to lock the assembly and hold the wings in their glide or drive positions. This gear has two perpendicular flat female slide lock surfaces because after it locks with one 90° segment of male slide lock ring it rotates 90°, locks with the opposite 90° segment of male slider lock ring, and then counter-rotates to return to its original position.

This dual female slider lock 197 is shown in detail in FIG. 44. Small roller bearings 199 can be mounted on the flat female locking surfaces 200, which reduces friction with the male slider lock surfaces of the stationary ring gear. The optional raised lip 201 guides and keeps this slider lock in place as it engages the ring gear, and also reinforces the mounting of the axial shaft for added structural strength.

The gearbox and housing 198 shown in FIG. 41 supports the geared transmission assembly and main hub and allows it to rotate independently of the main axle. The gears are mounted with circular roller bearings to reduce friction.

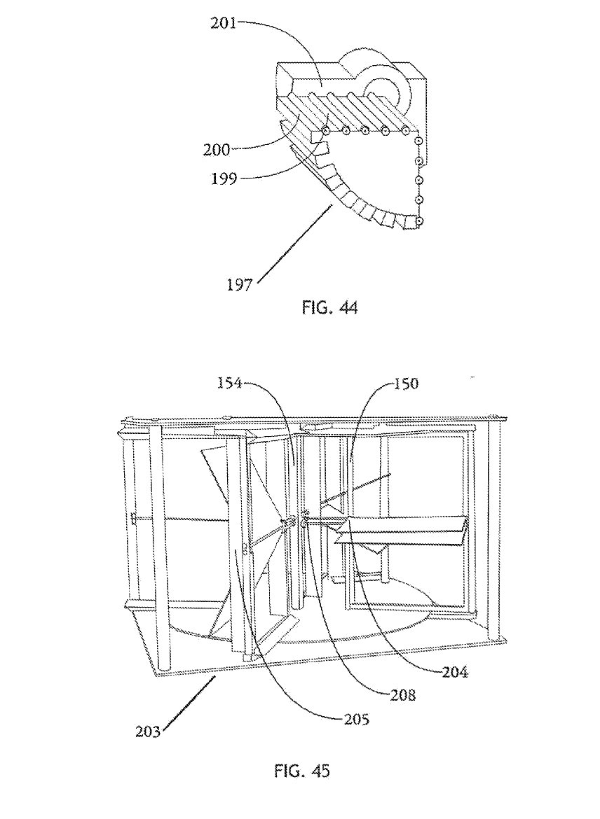

As shown in FIG. 45, instead of the wing and inner backstop assemblies being attached and radiating out from the side of the main shaft, the whole wing and backstop assembly are placed out away from the main shaft 154. This expansion of the sweep radius dramatically increases the lever arm of the wind force on the wings and thus enables the wings to deliver greater torque to the main shaft. By avoiding turbulence and drag associated with the areas surrounding the main shaft, tests have shown an immediate gain in rpm and loss of friction. The second advantage of this offset wing design is the dramatic increase in power from the wind fairings 205 placed at the outer edge of the wing's backstop 150. The box fairings of the incoming wings entering into the intake power drive quadrant do not block the current driving the previous set of engaged wings until late in those wings' drive cycles, as was the case in earlier models, because the wings in this model are set out away from the main shaft. Consequently the incoming wings' wind fairings have little effect on the current delivered to the wings currently engaged in the drive cycle. Because the fairings are fixed 90° to the closed wing, the fairings naturally extend outside the wings' turning radius as the wings engage in their ninety degrees of drive. As well as lessening lateral current escape, the added operating radius further increases leverage and torque delivered to the main shaft. Tests have shown that outer fairings as large as one third of the surface of the wing will actually increase rotational velocity. Because these turbines are scalable, the outer placement of wings relative to the main shaft is only structurally limited. Also seen in this illustration are the small adjustable weights 208 on the pivot shafts that make it possible to fine tune the balance of the turbine to reduce any wobble or vibrations in order to maximize the turbine's efficiency.

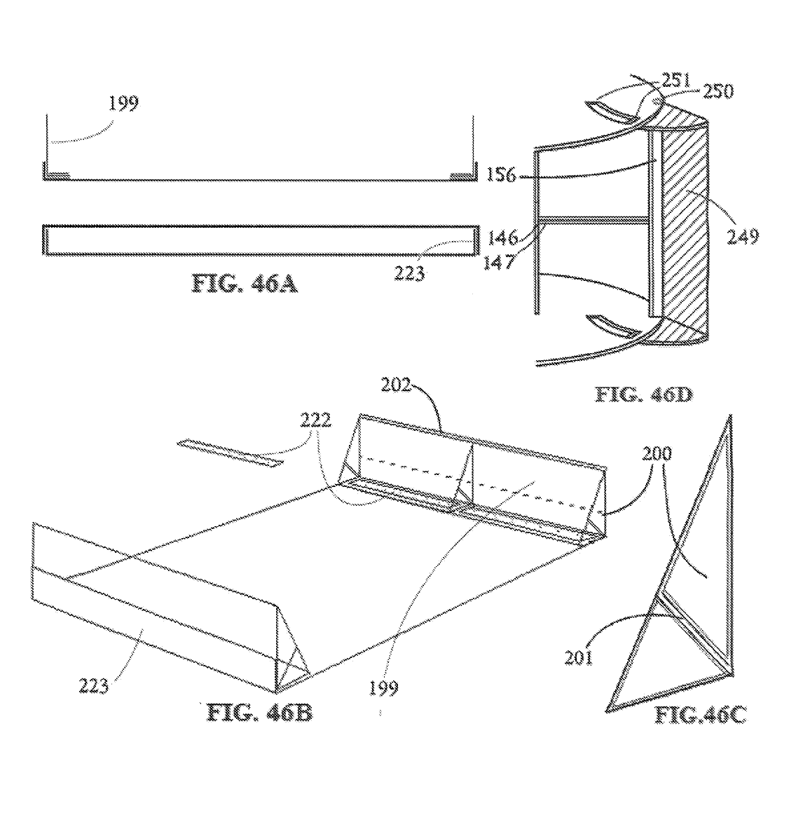

As seen in FIGS. 46A-46C, the perimeter or sides of the wings can be turned up at the edges, creating a mini fairing 223 that increases the structural strength of the wing and also adds to current capture in the transition to glide cycle, creating lift with little or no drag.

FIG. 46A-46C feature a collapsible cloth wind fairing 249, here constructed from strong flexible durable synthetic fabric. Struts 244 and hinge 246 are both made from cut and hemmed fabric. The hinges or fold lines are made by sewing two or more triangular pieces of fabric together and hemming them adjacent to one another on a single layer of fabric. This fold line forms a hinge 246 made of a single layer of fabric. The wind fairing then naturally hinges where there is only one layer of fabric. To strengthen the edges a cord or wire binding 245 can also be sewn into the outer edge of the cloth fairing. The wind causes these collapsible wind fairings to blow open when facing into the oncoming current. They function like fixed wind fairings, increasing the capture of current flow, and collapse when the hinged wing closes in its glide position. A flat rectangular metal strip 247 attached to the wing can be used to sandwich the cloth fairing into place. The rigid hinged wind fairing shown in 46D operate in much the same manner as the cloth fairing. Both fairings are attached to the side structure 156 and move out in trans-drive and drive extending the radius of the sweep area while tracking to a position of least resistance in the trans-glide and glide cycles of the turbine's rotations. The rigid fairing in this example has a hinge 250 attached to the side structure 156 to accommodate this radial movement, with cushioned stop 251 built into the upper and lower turbine assembly rims to cushion and limit movement to its inward retracted and outward extended position.

This turbine can also be used a propulsion system for a ship. With reference to FIG. 51 instead of sails this ship 126 deploys one or more side-by-side twin turbines 127 to generate power for forward movement. The turbines 127 is mounted above deck on a rotatable support 128, with tail 129 acting as a weather vane to keep the turbines pointed into the wind for maximum power generation. Thus, electrical power generated by the wind turbines 127 described herein may be delivered to an electrical propulsion system for the ship, enabling the ship to go in any direction desired regardless of the direction of the incident wind. If the wind turbines comprise a large mass and wind load above the waterline, the ship may be provided with pontoons 131 extending to port and starboard that may be retracted out of the water or extended outward and downward for example on hydraulic arms 132 to keep the ship from listing from one side or the other when the wind is blowing from either beam direction.

One particular embodiment of the present invention provides for a consolidated pivot shaft, wherein one of the pivot shafts in of a parallel pivot shaft pair is hollow and the other pivot shaft of the parallel pivot shaft pair traverses the hollow of the hollow pivot shaft. Critical to the highest production of the turbine's efficiency is the reduction of the mechanism drag resistance in the glide side of the sweep area.

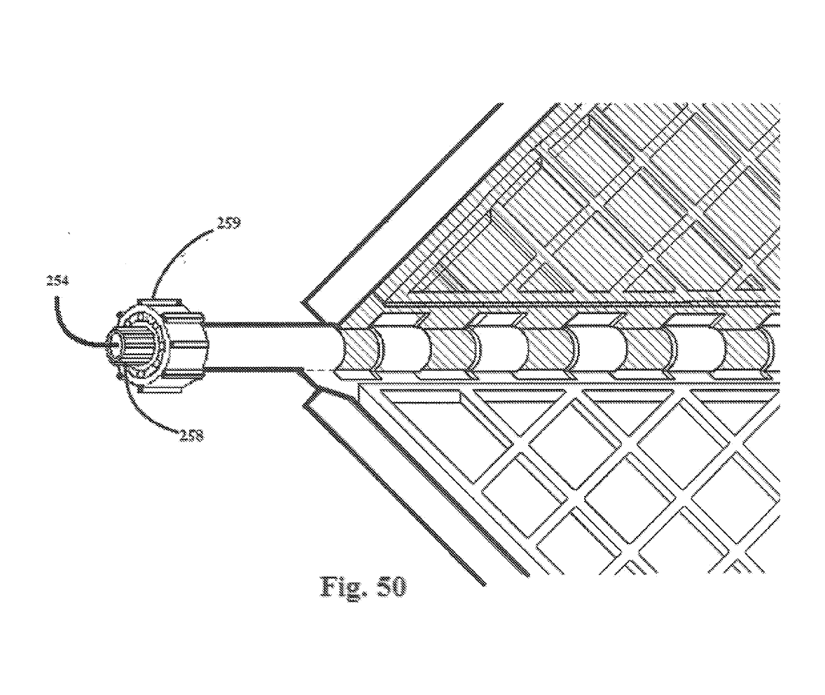

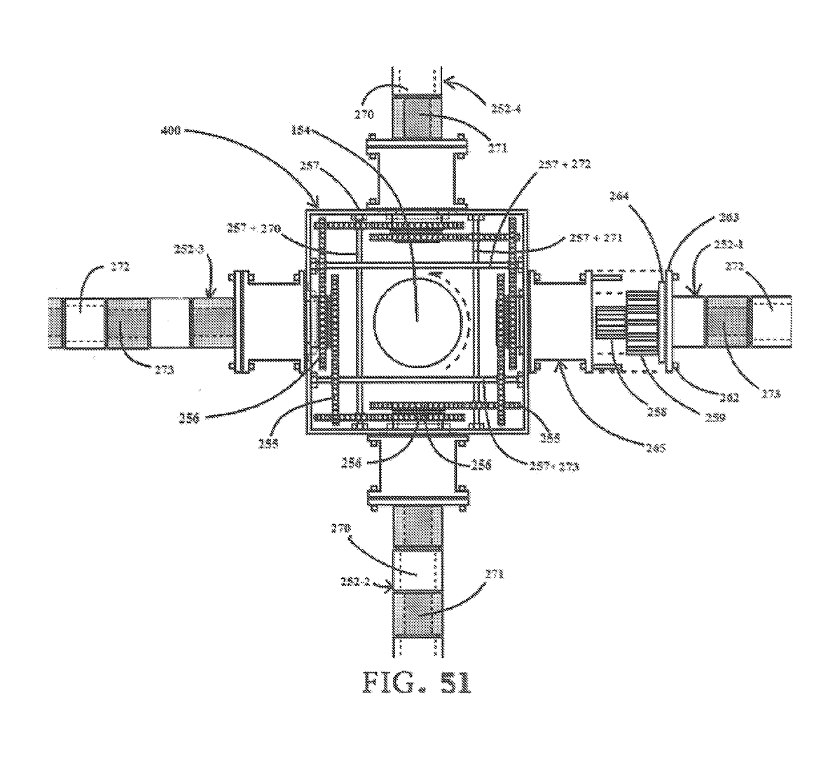

FIGS. 50 and 51 depict the a consolidated pivot shaft where the parallel pair of pivot shafts 146 and 147 depicted in FIGS. 26 and 27 have been concentrically consolidated one inside the other into into one tubular housing. Each of the concentrically arranged pivot shafts is connected to a wing.

FIG. 50 shows one embodiment of a consolidated pivot shaft, using a traditional hinge design with one half of the hinge attached to a pivot shaft that transition its wing up into drive, type U pivot shaft (shown as the upper crosshatch section of the drawing) with the other half of the hinge attached to a pivot shaft and wing that transitions its wing down into drive type D pivot shaft and wing. FIG. 50 is an illustration of a consolidated pivot shaft and wing assembly henceforth referred to as CPSWA 252. Each CPSWA 252 consist of two pivot shaft sections each section attached to a wing and each section with a spline at its transmission end, splines 258 or 259. Each CPSWA 252 also has a connecting flange 263 with a bearing that attaches the CPSWA 252 to its transmission. Referring to FIG. 51, turbine having eight wings create four such CPSWAs 252-1, 252-2, 252-3, 252-4. All four CPSWAs connect to the side of the dual drive transmission 400 depicted in FIG. 51 when splines 258 and 259 are inserted into matching socket 260 and 261(sockets shown in FIG. 54), which are inside their socket housing 265 along with the pivot shafts and outer bearing. As shown in FIG. 51, splines 258 and 259 and their assembly 252-1 can be inserted into sockets inside of socket housing 265. Each of the four assemblies are thus attached and secured in place by a flange 263 and its fasteners 262.

In addition to reducing the glide profile there are many other useful advantages associated with this detachable consolidated pivot shaft assembly design relating to performance, manufacturing, and maintenance.

The dual drive transmission 400 is to gears each CPSWA 252 with a counterpart on the opposite side of the transmission. Consequently, when the type U “up” and type D “down” pivoting shafts in one CPSWA 252 are transitioning their wings into a drive position their counterpart CPSWA 252 and its two wings on the opposite side of the transmission are transitioning their two wings into a glide position. As illustrated in FIG. 50 both the type “U” pivot shaft and type “D” pivot shaft are placed one inside the other forming a tubular housing that rotates on a stationary axle 254.

Thus all four wings in the two counterpart CPSWA assemblies are always counterbalanced, both vertically and diagonally. The wings are counterbalanced vertically with one of the two wings and its pivot shaft for example pivot shaft 272 of one CPSWA 252 with its wing moving up into drive, while simultaneously the other wing and pivot shaft 273 in the same CPSWA 252 is moving down into drive. In other words one wing is going up into a drive position as the other wing is going down into drive position. Each of the two wings of one assembly 252 are also diagonally counterbalanced across the sweep area with a wing in the connected corresponding CPSWA 252 on the opposite side of the transmission, in the same manner as previously described in parallel pivot shaft designs.

For example, referencing FIG. 51, as pivot shaft and wing 272 in 252-1 is transitioning up into a drive position its companion wing in 252-1 is moving down into a drive position as the counterpart wings and pivot shafts in 252-3 diagonally across the transmission from it simultaneously has its pivot shaft and wing 273 going up into a glide position and wing 272 going down into a glide position.

These two counterpart CPSWA 252 assemblies with their four wings and connections henceforth will be designated as a compound assembly. In a preferred embodiment, each turbine has two such compound assemblies, each compound assembly running perpendicular to the another through the dual drive transmission 400. One compound assembly is composed of assembly 252-1 and 252-3 including its drive train through the transmission and the other compound assembly 253 is composed of assembly 252-2 and 252-4 and its drive train through the transmission as shown in FIG. 51. The main purpose of the dual drive transmission 400 is to connect each wing in each CPSWA 252 to one of the pivot shafts in its counterpart CPSWA 252 on the opposite side of the transmission through an independent drive train. Again, in a preferred embodiment each turbine has four CPSWA 252 assemblies defining two independent compound assemblies 253, each of which run perpendicular to one another through the dual drive transmission 400. Each turbine's transmission independently regulates the pivot shafts and wings of each of the two compound assemblies 253. The first compound assembly, 253 with its assembly 252-1 and 252-3 are connected through their respective gear train running through the transmission in one direction, and the second compound assembly 253 with its assembly 252-2 and 252-4 are also connected to each other and run perpendicular and independent to the first assembly 253. Thus the double assembly 252 with its set of shafts 272 and 273 are connected to each other making one compound assembly 253 as is double assembly 252 and their set of shafts 270 and 271 also connected together with their own independent geared drive train making the other compound assembly 253 operating perpendicular and independent of one another through the dual drive transmission 400 as is shown in FIG. 51.

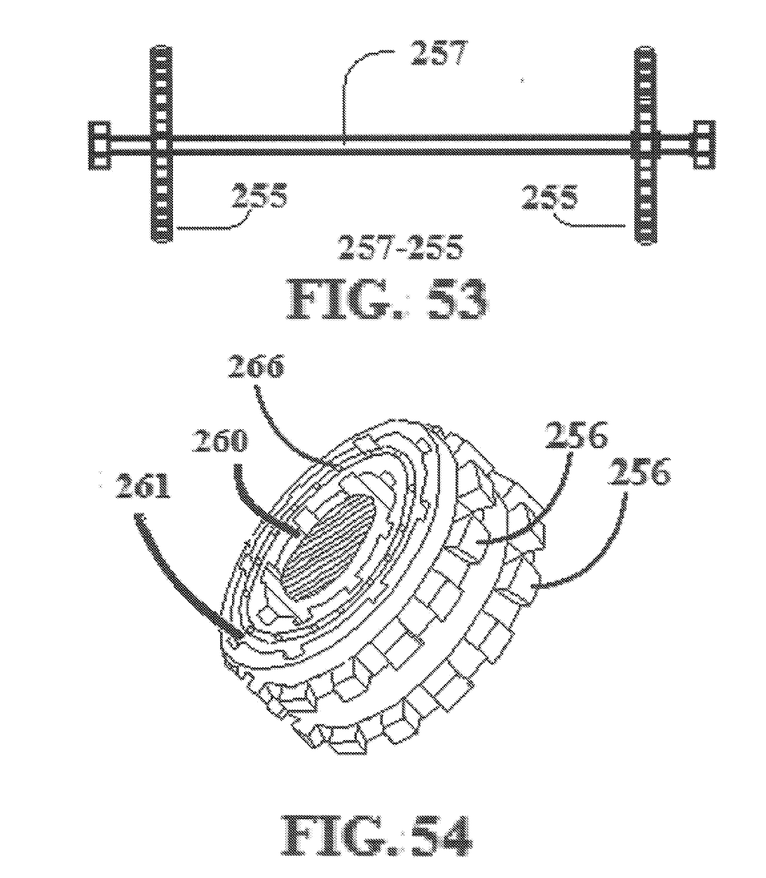

Each CPSWA 252 has two pivot shafts as described above. Each pivot shaft has a spline on its connecting end as shown in FIG. 50. Each spline is inserted into a corresponding independently moving socket, socket 260 that interfaces with the gears on spline 258 and socket 261 that interfaces with spline 259. Each CPSWA 252 is secured at the sides of dual drive transmission 400 with connecting flange 263 and fasteners 262, as seen in FIG. 51. Transmission sockets 260 and 261 each have outer socket gears 256 seen in a perspective view in FIG. 54. Each outer socket gear 256 meshes independently with its own transmission gear 255. Each transmission gear 255 is connected to the end of transmission drive shaft 257 that has an identical gear 255 at its other end. This transmission drive shaft with attached gears is designated as 257-255 and is seen in FIG. 53. The gear 255 on pivot 257 engages with its corresponding identical socket gear 256 that attaches to spline 258 or spline 259 of the counterpart CPSWA on the opposite side of the transmission. Thus, each of the two spline gears of each CPSWA 252 are independently attached inside the transmission through their own independent drive shaft gear assemblies 257 and 255 to the wing across from them in the other assembly 252 on the opposite side of transmission 400. Each wing in each CPSWA 252 is attached to its transmission drive shaft in a position that secures the wings of one CPSWA 252 in a geared position that is 90 degrees to its counterpart wing on its counterpart CPSWA 252.

For example, as one CPSWA 252 is transitioning its wing clockwise up into drive its connected drive train gear 255, axle 257 and gear 255 at the other end of axle 257 are all moving 90 degrees counterclockwise rotating the spline gear of the CPSWA 252 at the other side of the transmission clockwise down into glide. As illustrated in FIG. 51 both 252-1 and 252-3 consolidate an inner pivot shaft 272 and outer pivot shaft 273. Each inner and outer pivot shaft is connected to its counterpart pivot shaft through the transmission's drive train. The same is true of 252-2 and 252-4 consolidating inner and outer pivot shafts 270 and 271.

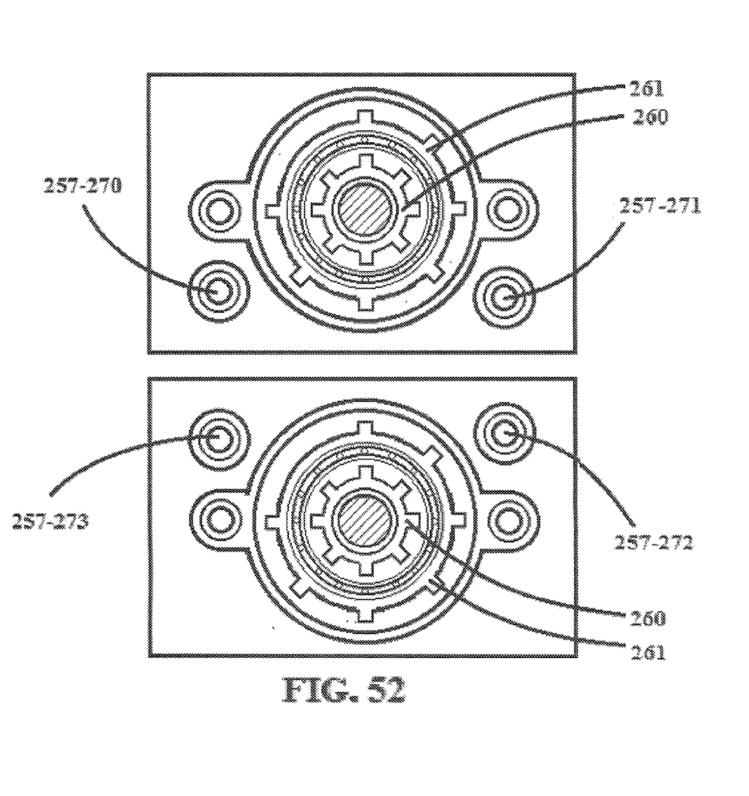

The two transmission drive shafts 257 of one assembly 253 transverse through the transmission under its centered sockets 260 and 261 as shown in the upper transmission side view of FIG. 52, allowing space for the other assembly's 253 drive shafts 257, running perpendicular to it, (shown in the lower transmission side view of FIG. 52) to transverse through the transmission over its centered socket 260 and 261. In between the two pivot shafts in each assembly 252 are bearing s (not shown) so each shaft can freely and independently counter rotate 90 degrees. Inside the transmission each socket is surrounded with a perimeter socket gear 256. A detail of the perimeter socket gear is seen in FIG. 54. Each socket gear independently turns on bearing 266 back and forth 90 degrees. The socket gears are of the exact size as each of the two transmission drive gears 255. The socket gears likewise rotate the transmission drive gears 255 back and forth 90 degrees. It is noted that this transmission design is one possible way to achieve the resulting objectives thus stated.

The foregoing description of a preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A fluid turbine assembly for converting fluid flow into rotational movement for useful work, including:
a central drive shaft assembly rotatable about a central axis;
a plurality of pivot shafts, each extending transversely to said central axis and supported on said central drive shaft assembly by bearing means, each of said pivot shafts having a respective pivot axis extending longitudinally therethrough;
a plurality of wings secured to said pivot shafts, each of said wings secured to an end portion of each of said pivot shafts, each of said wings extending in planes that pass through the respective pivot axis of their respective pivot shaft;
said plurality of pivot shafts comprising paired pivot shafts extending in parallel relationship, one of said plurality of wings extending from each of said adjacent end portions of said paired pivot shafts and defining an adjacent pair of wings;
said paired pivot shafts being reciprocally rotatable about their respective pivot axes from a drive position in which said adjacent pair of wings extend generally parallel to said central axis and transverse to incident fluid flow to maximally impinge on said fluid flow and rotate said central drive assembly, to a glide position in which said adjacent pair of wings extend generally transverse to said central axis and parallel to incident fluid flow to minimize drag.

2. The fluid turbine assembly of claim 1, further including gear means for coupling said paired pivot shafts for pivoting to move said plurality of wings from said drive position to said glide position.

3. The fluid turbine assembly of claim 2, wherein said gear means includes a plurality of meshing gears, each meshing gear being secured to one pivot shaft of each pair of pivot shafts and disposed to form a meshing gear pair with another meshing gear secured to the other pivot shaft of said pair of pivot shafts, whereby said pair of pivot shafts are driven to counter-rotate in generally similar angular excursions between said drive position and said glide position.

4. The fluid turbine assembly of claim 3, further including transmission means for rotationally linking said pairs of pivot shafts to rotate sequentially in concert to move each of said opposed pair of wings to said drive position as they rotate about said central axis into the incident fluid flow and to said glide position as they rotate away from the incident fluid flow.

5. The fluid turbine assembly of claim 4, wherein said transmission means includes a sun gear assembly disposed concentrically about said central drive shaft assembly, and a plurality of planetary gear assemblies, each engaged between said sun gear assembly and one of said meshing gear pairs joined to a respective pair of pivot shafts.

6. The fluid turbine assembly of claim 5, wherein said sun gear assembly is fixed and non-rotating.

7. The fluid turbine assembly of claim 5, wherein each of said planetary gear assemblies includes two pair of planetary bevel gears mounted on a common planetary shaft, each pair of planetary bevel gears disposed to engage one of said meshing gears.

8. The fluid turbine assembly of claim 7, wherein said sun gear assembly includes sun bevel gears disposed to engage said planetary bevel gears, said sun bevel gears extending in partial circumferential arcs about said central axis.

9. The fluid turbine assembly of claim 3, wherein each one of said pair of pivot shafts extends generally radially outwardly from said central axis and in diametrical opposition to another pair of said pivot shafts, and further including linking means for joining a pivot shaft of said one pair of pivot shafts to a pivot shaft of said another pair of pivot shafts, whereby each of said diametrically opposed pairs of shafts are joined in rotational motion.

10. The fluid turbine assembly of claim 9, wherein said linking means includes a linking shaft that extends adjacent to said central shaft assembly.

11. The fluid turbine assembly of claim 4, wherein said transmission means includes a ring gear assembly disposed concentrically about said central drive shaft assembly and having annular toothed portions disposed to engage said meshing gear pairs and rotate said pairs of pivot shafts.

12. The fluid turbine assembly of claim 11, wherein said ring gear assembly is rotationally fixed, and said annular toothed portions engage said meshing gear pairs sequentially as said central drive shaft rotates about said central axis.

13. The fluid turbine assembly of claim 12, wherein four of said pairs of pivot shafts are provided, and said annular toothed portions extend annularly approximately 90°.

14. The fluid turbine assembly of claim 8, wherein four of said pairs of pivot shafts are provided, and said partial circumferential arcs extend annularly approximately 90°.

15. The fluid turbine assembly of claim 1, wherein each of said pair of pivot shafts are disposed in planes that are parallel to said central axis and spaced apart radially from said central axis, and also closely spaced apart in the axial direction.

16. The fluid turbine assembly of claim 15, wherein said pairs of pivot shafts are interdigitated in the axial direction.

17. The fluid turbine assembly of claim 15, wherein said pairs of pivot shafts are located generally in the same plane extending transverse to said central axis.

18. The fluid turbine assembly of claim 1, wherein each of said pair of pivot shafts are disposed in planes that generally coincide with said central axis and also closely spaced apart in the axial direction.

19. The fluid turbine assembly of claim 18, wherein said pairs of pivot shafts are interdigitated in the axial direction.

20. The fluid turbine assembly of claim 18, wherein said pairs of pivot shafts are located generally in the same plane extending transverse to said central axis.
